(19) United States
(12) Patent Application Publication
(10) Pub. No.: US 2001/0026609 A1
(43) Pub. Date: Oct. 4, 2001

(54) Method and apparatus facilitating the placing, receiving, and billing of telephone calls

(76) Inventors: Lee Weinstein, Arlington, MA (US); Scott Brown, Wimberly, TX (US)

Correspondence Address: LEE WEINSTEIN, 35 FAIRMONT ST #3, ARLINGTON, MA, 02474, US

(21) Appl. No.: 09/752,365

(22) Filed: Dec. 29, 2000

Related U.S. Application Data
(60) Provisional application No. 60/173,923, filed on Dec. 30, 1999.

(51) Int. Cl. H04N 7/14; H04M 11/00; H04M 1/56; H04M 15/06

(52) U.S. Cl. 379/93.01; 348/14.01; 379/142.01; 705/26

(57) ABSTRACT

A method and apparatus facilitating web-initiated communication by telephone, providing for both anonymous and non-anonymous communication, which allows users to contact each other through a trusted central connecting facility provides breakthroughs in personal control, privacy, and safety for people communicating over the telephone. All calls are incoming calls, both to callers and call recipients. Users may control what time windows they can receive calls from other users, on an individual basis. Billing for professional services delivered over the phone may be done automatically through the call delivery system. Both one-to-one and group calls are provided. An auction feature allows customers to bid for phone time with desired personalities. Calls may be scheduled to happen automatically at pre-arranged times. Use of PIN codes prevents unintended recipients from receiving a call. Users may generate temporary contact number cards which an be given out to people they meet, such that calling access will be controllable and traditional contact information (such as phone number and address, full name, etc.) can be kept private. Users may sign up for paid accounts or free accounts. Free accounts may only receive calls and make collect calls. Applications include dating websites, on-line greeting cards with a phone call contained, phone connection during on-line chat, customer service, time-controlled phone contact for on-line auctions, supplemental long-distance and international calling, and fund-raising.

This application claims priority to provisional patent application No. 60/173,923 (filed Dec. 30, 1999). The invention relates generally to placing and receiving telephone calls, privacy in communication, fund-raising, and billing for professional services and telecommunication services; and more specifically to controlling telecommunication via the world-wide web, the placing and receiving of anonymous telephone calls, scheduling and automatic placement of phone calls, and call recipient control of who can call and when.

### BACKGROUND

The telephone and the internet are probably the two most important inventions of modern times concerning people's ability to connect with other people. The telephone brought people out of isolation, and perhaps because of the overwhelming benefit seen in reducing isolation, the telephone system was designed from the beginning with total accessibility as the default. Any person on the system could be called by any other person on the system at any time, and the default was that all names and telephone numbers were listed in publicly accessible directories.

By the time the internet came to be used by a large fraction of the public in the late 1990s, many people had come to perceive their “reachability” or “accessibility” by various communication mechanisms (phone, letters, fax, e-mail) as an annoyance as often as a benefit. By 1998, use of temporary e-mail addresses was on a drastic rise, and the use of unlisted telephone numbers continued to rise as well.

There is a distinct balance that people appreciate between their ability to maintain their privacy, and their ability to connect. People want freedom in their ability to contact others, and they want freedom in their ability to decide who can contact them. Trends continue toward providing consumers more freedom in each of these directions. Free voice-mail and fax services have become available from numerous providers on the internet. These services provide consumers free voice mail boxes and fax numbers which forward compressed voice and fax files to an email address provided by the consumer. A wide variety of free e-mail services exist which allow consumers to have a number of e-mail addresses, and free storage space associated with each one of them. These free services allow consumers to have different contact information that they give to different groups of people or individuals. This freedom is valued by consumers (though managing it all can be a bit unwieldy). The caller ID service available from the telephone company is marketed to call recipients as a way to control their privacy by identifying and screening callers, while callers who don't wish to be identified are placated by a feature that allows any caller to block their caller ID from being sent out. This blocking feature can be selected for a single call or for all outgoing calls.

Anonymous social introduction services (both free and paid services) such as dating services, printed publications which carry personal ads, and internet personal ad services have been increasing in popularity steadily for years. Part of the appeal of these mediums for meeting people is the tremendous variety of people, and the sheer quantity of people who can be met this way. Another part of the appeal of these social mediums is that they provide various means through which people can communicate anonymously before deciding to actually exchange phone numbers or meet in person. Features such as bi-directional anonymous e-mail forwarding used on many internet personals websites (such as Yahoo Personals) provide people the ability to send and receive e-mail messages without actually knowing the identity or even the “real” e-mail address of the person they are communicating with. Anonymous communication can be particularly important to women, who often consider anonymity a key component of their ability to insure their personal safety. Thus, the caller ID system doesn't allow full privacy control either calling or called parties.

A method of anonymous communication via telephone is disclosed by Solomon in U.S. Pat. No. 4,847,890. Solomon's method requires the user to dial an intermediate phone number and enter an access code. This may mean the dialing party has to enter a total of about 25 digits to reach the called party. Systems utilizing Solomon's technology have been implemented on a limited basis and were not a commercial success.

At the same time as consumers are demanding more ability to maintain their privacy and more ability to connect, they are also hungry for cheaper ways to connect and simpler ways to connect. Recent deregulation of the telephone companies has lead to access to a tremendous variety of long-distance services through the dialing of five-digit prefix codes. Consumers are barraged with advertisements from different long-distance carriers offering different deals. Sorting out the real cost of these offers can be an ordeal. Each have different benefits and different drawbacks. Some can only be accessed by dialing a five-digit code before the phone number, while others can be selected for “one plus” dialing. Many have monthly surcharges or other “hidden” charges. The cheapest way in which long-distance can be purchased on the present market in the form of pre-paid calling cards, which presently offer rates as low as 3.9 cents per minute, while the lowest rates available for “one plus” long distance are on the order of five cents per minute, and more typical rates are on the order of 10 cents per minute. While some of the pre-paid phone cards are a great bargain, they are cumbersome to use. One must dial an access number, then enter a pass code, then dial the number to be reached. This can easily take a minute longer than dialing a regular number, and the dozens of digits needed provide ample opportunity to make dialing mistakes. In general, the best value and the best convenience have not coincided in the telecom market.

### SUMMARY OF THE INVENTION

The present invention provides a method and apparatus for consumers to place telephone calls by clicking links on a an internet-connected data terminal such as a PC or a PDA or a WEb-TV or a WAP-enabled cell phone. The calls are placed by a central service which dials the call placer, dials the intended recipient, and connects the two together. If one of the phones is busy, the person sourcing the call gets a dialog box providing the option for the call to be scheduled to take place a known amount of time later, or when the busy phone becomes reachable. It is an object of the present invention to provide a means for integrating the placement of telephone calls with a wide variety of web-based applications, including but not limited to personal ads, auction listings, and electronic greeting cards, as well as to provide an alternate means for placing and billing local, long-distance, and international phone calls.

The present invention further provides means for people to communicate anonymously via telephone through a trusted centralized anonymous communication service. Both parties are called (and then connected together) by the central service in response to a website click initiated by one of the parties. In a preferred embodiment, no numbers need to be dialed by hand and no access codes need to be entered, so the system is very easy for the consumer to use, providing true “one click” dialing In a preferred embodiment, each party to an anonymous communication must be a “member” of the service.

It is an object of the present invention to provide consumers with an extremely convenient, low-cost method of dialing telephone numbers. It is a further object of the present invention to integrate telecommunication with other, previously un-linked methods of connecting with other people, such as e-mail, internet chat, on-line postings, etc.

It is a further object of the present invention to provide consumers with easy access to information which they can use to control their level of accessibility by telephone.

It is an object of the present invention to maximize the control which call recipients may exercise over who may call them, and when. Unlike previous technologies, the central communication service calls both parties to make the connection, so there is always a record of who called who (for anonymous calls, this record is coded by anonymous ID). This record is always available to users, so it is always possible to block calls from a given individual if desired. In a preferred embodiment, anonymous calls can be received from a given individual or group only if the receiving party has specifically enabled reception from that individual or group within the trusted central system.

It is an object of the present invention to provide access to the widest possible market. This is accomplished partly through allowing members to configure billing differently for each contact. Calls may be accepted from a first set of contacts only if they “foot the bill”, while calls may be accepted from a second set of contacts such that the billing is split between caller and called party, and calls may be accepted from a third set of contacts where the called party pays the entire bill. Thus, a significant portion of the customer base may be using the system for free, and will not need to provide billing information when they sign up. Unlike previous telecommunication systems, the same phone number may function like an “800 number” to some callers, and as a toll number to other callers. Alternately, businesses could set up parameters so that the first N calls from a particular customer were toll-free, and after that the customer got a dialog box informing him or her that allotted toll-free customer service calls had been used up and they would now be billed at a particular rate.

A feature which allows members to generate temporary passwords allows women a way to safely give men a way to anonymously contact them, whether or not the man is presently a member. Women can feel safe doing this, knowing that a man they give a temporary contact number to will only be able to contact them when they are interested in being contacted, and knowing that their identity and/or personal contact information such as their address (which can be easily obtained from a regular phone number) will not be known until such time as they may wish it to be known.

In today's hectic world where so much of our lives is tightly scheduled, it is an object of the present invention to reduce the number of things people need to remember in order to keep their appointments and contact the people whey want to reach. A call-scheduling feature in the present invention allows anonymous calls to be scheduled at pre-agreed times. The calling system calls both parties at the pre-agreed time and connects them anonymously. Another feature designed to let people “set it and forget it” allows users to have the system automatically set up an anonymous connection as soon as a busy number becomes free.

To offer further convenience, each customer's full dialing database may be uploaded to a centrally accessible database, and phone numbers may be dialed simply by clicking names, or by entering aliases instead of phone numbers.

It can be stressful or undesirable to have someone be able to call you at any time. A woman might not, for instance, want to be able to receive calls from one man she is dating while another man she is dating is at her house. The present invention allows users to experience more control over their privacy by allowing users to set different allowable-call-reception-time windows for each person from whom call reception is enabled.

Call reception may be enabled on an individual or group basis. A group may be enabled, for instance, by placing a “click to call me” link directly in a personal ad. The “group” that is enabled in this case is the set of all people who encounter that ad. An individual might be enabled to call by sending an e-mail containing a “click to call me” link to an individual, or by using a feature of the present invention to automatically set up a clickable link in another person's account on the system.

Another way that the present invention allows control of privacy is through the use of PIN codes. A normal telephone call coming in to a household could be answered by anyone in the household. The present invention allows users to further protect their privacy by requiring the entry of a valid PIN code before the person answering the phone may receive the incoming call. This provides added safety if someone other than the intended call recipient answers the phone. An additional audio menu after the PIN entry allows the intended call recipient to reply with one or more pre-arranged messages (such as “I can't talk right now. Please call me back later.”) without actually speaking those messages. This allows communication and can avoid embarrassment and increase safety in situations such as when a woman sets up her allowed call reception times such that one suitor happens to be allowed to call while another suitor is at her house.

Yet another way the present invention increases control, privacy, and peace of mind is that the person receiving a call need not actually speak to the person calling to put the call off until later, or to completely refuse the call and disable the caller from being able to call in the future. Commands to do these and other things can be entered by touch-tone or voice before the calling party is actually connected.

The ability to remain anonymous during repeated live interactions with others facilitates people learning and growing by experimenting with different styles and personas of interacting with people, whereas people might feel hesitant to try out new personas around people who already know how they “really are”. People using Internet chat rooms often have different pseudonyms they use to try out different personas. The present invention allows this safe experimentation to be extended to live voice interaction.

The present invention provides new freedom for people in situations where they want or need to carry on a business or personal relationship with another person while remaining anonymous over a period of time. For instance, if a couple is living together and the woman feels the man has been abusing her, but that she will be alone if she leaves, the fear of the unknown (being “alone”) is often stronger that the pain of being in the difficult situation which is known and familiar. The present invention facilitates people in such difficult situations establishing new relationships and allowing those relationships enough time to grow and become familiar so that the person can more easily leave their difficult circumstances, more confident about the possibilities that lie ahead.

To increase safety still further for people in difficult situations, the present invention allows for anonymous calls to be made and received without having to pay for an account, as long as the other party to the calls accepts the billing. A person with a free account would have no tell-tale bills for someone living with them to get suspicious about.

All these features combine to produce a quantum leap in the level of control, peace of mind, and safety experienced by users in communicating with people, and can significantly increase quality of life in the social arena for many people. Another way in which the present invention can increase the quality of life in the social arena is by saving time for both men and women. Typically in using today's internet personal ad systems, a woman may e-mail back and forth a number of times with a man before deciding to call him or give him her phone number. Using the present invention, a woman can feel free to have a phone conversation much earlier in the process of meeting a man. Talking can be a much faster way to learn if someone would be interesting to date, so the present invention can save a lot of time and angst on the part of both men and women.

It is a further object of the present invention to facilitate the more equitable marketing of people's time on the phone, and to provide heightened levels of convenience in signing up for, receiving, and paying for people's time on the phone. Many people make all or part of their living providing expert advice or counsel on the phone. The present invention provides means for customers to schedule phone time with experts, and automatically receive and pay for the phone calls at the scheduled times.

An additional feature allows people to bid against each other to compete for time on the phone with someone. This feature might be used, for instance, to allow a tax expert to most fairly price his or her time on the phone near April 15th. Another way in which the time auction feature might be used is in fund raising, where people might bid against each other to take part in a teleconference with a celebrity, who hosts the teleconference to raise money for his or her favorite charity.

In combination with the anonymous communication system disclosed by Solomon in U.S. Pat. No. 4,847,890, the present invention provides substantial improvements to the workability of Solomon's invention, making practical the administration of large complex lists of callers, and thus making practical password-protected public phone numbers. In such an application, incorporation into the switching networks of public telephone companies can provide telephone service in which every caller must have pass code in order to reach a given telephone number. An alternative to entering the pass codes may be provided by providing voice analysis, such that each caller who dials a pass-code protected number for the first time uses a pass code (which might be long, to prevent hacking), and after successfully entering the pass code, the caller speaks a phrase, which on which voice analysis is performed. In subsequent calls, the caller need only speak the phrase to be allowed access after dialing the number. Password protection might be particularly desirable on toll-free numbers.

### BRIEF DESCRIPTION OF THE FIGURES

FIG. 1: Example of a personal ad on a personal ad website.

FIG. 2: Example layout of a web page used for writing an initial anonymous e-mail response to a personal ad.

FIG. 3: Example layout of a web page containing an anonymous e-mail communication concerning a personal ad.

FIG. 4: Example layout of a home page for a website through which customers can sign up for and access web-initiated long distance, international, and anonymous calling services.

FIG. 5: Example layout of an Anonymous Calling Account Management web page showing a list of enabled callers and a summary of their enabled call times, a list of disabled callers, a history of completed calls, and a list of scheduled “outbound” calls.

FIG. 6: Example layout of a Contact Management web page for managing times and dates of allowed call reception from a selected caller, and scheduling calls to other members.

FIG. 7: Example account sign-up screens for an anonymous calling service.

FIG. 8: Major functional blocks of the present invention and data paths connecting these blocks.

FIG. 9: Flow diagram showing the method of contacting the second party to an anonymous call once the first party to the call has been contacted.

FIG. 10: Flow diagram showing the placing of an anonymous call initiated over the web.

FIG. 11: Example layout of confirmation page for web-page-initiated call.

FIG. 12: Example layout of temporary pass cards as they would be printed on pre-perforated paper.

FIG. 13: Example layout of a web page for selecting default preferences for the configuration of new anonymous contacts.

FIG. 14: Example layout of a web page offering dialing and configuration options in response to the clicking of a dialing link.

FIG. 15: Example of an on-line greeting card including a clickable phone-dialing link.

FIG. 16: Example layout of a ClickCall Account Management web page facilitating the dialing of long-distance and international numbers, showing account balance, allowing lookup of dialing rates, and allowing access to a history of completed calls.

FIG. 17: Example layout of a web page for choosing the dialing options of an on-line link (such as might be sent in an on-line greeting card).

FIG. 18: Example web page on which service providers can specify times that customers may schedule telephone time with them.

FIG. 19: Example web page through which customers may schedule phone time with service providers.

FIG. 20: Example dialog box for confirming time signup with service provider.

FIG. 21: Example web page for bidding to participate in a celebrity fund-raising teleconference (time auction), and showing additional time raffle feature.

FIG. 22: Example dialog box for confirming a bid in a time auction.

FIG. 23: Flow chart showing the sequence of events in bidding to participate in an auctioned teleconference, choice of who gets wait-listed, who gets entered into the e-raffle, and how final participants are selected, billed, and dialed.

### DETAILED DESCRIPTION OF USE IN ANONYMOUS COMMUNICATION

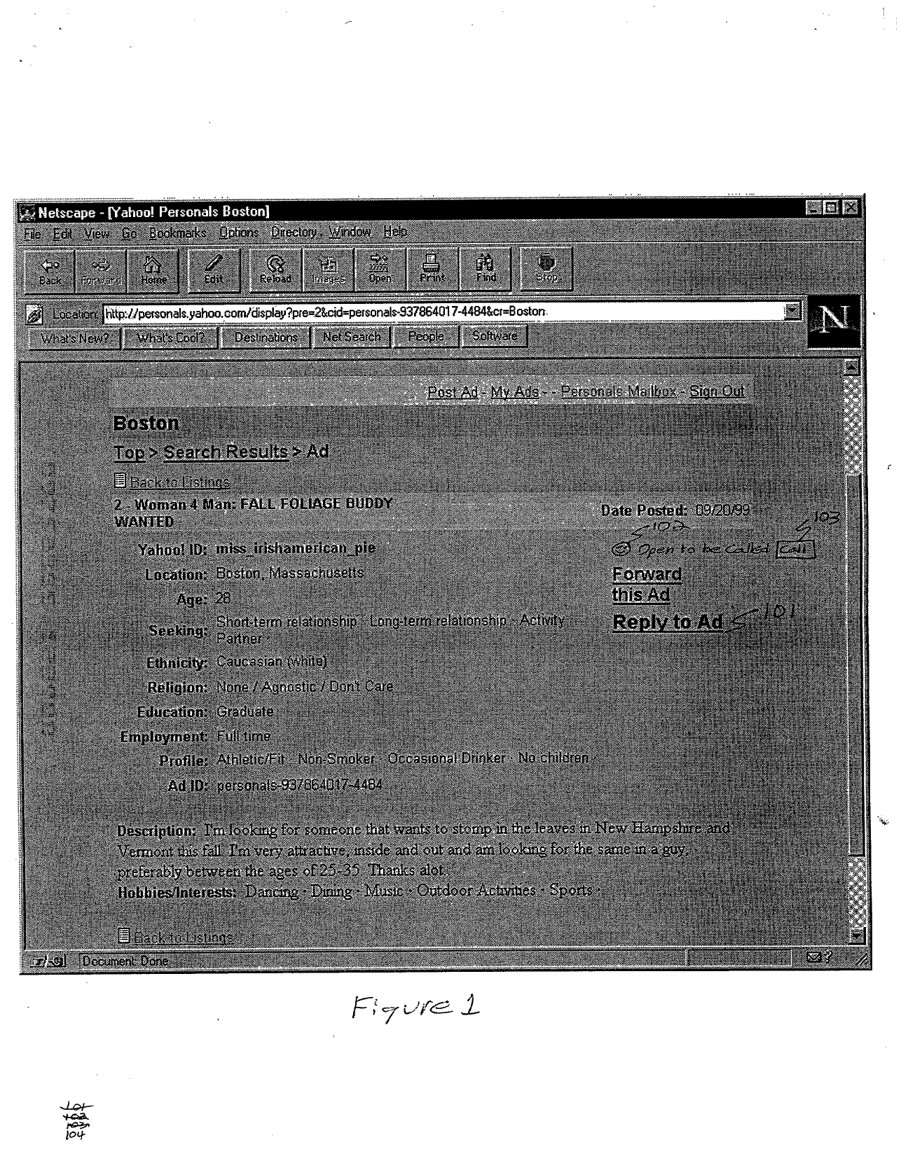

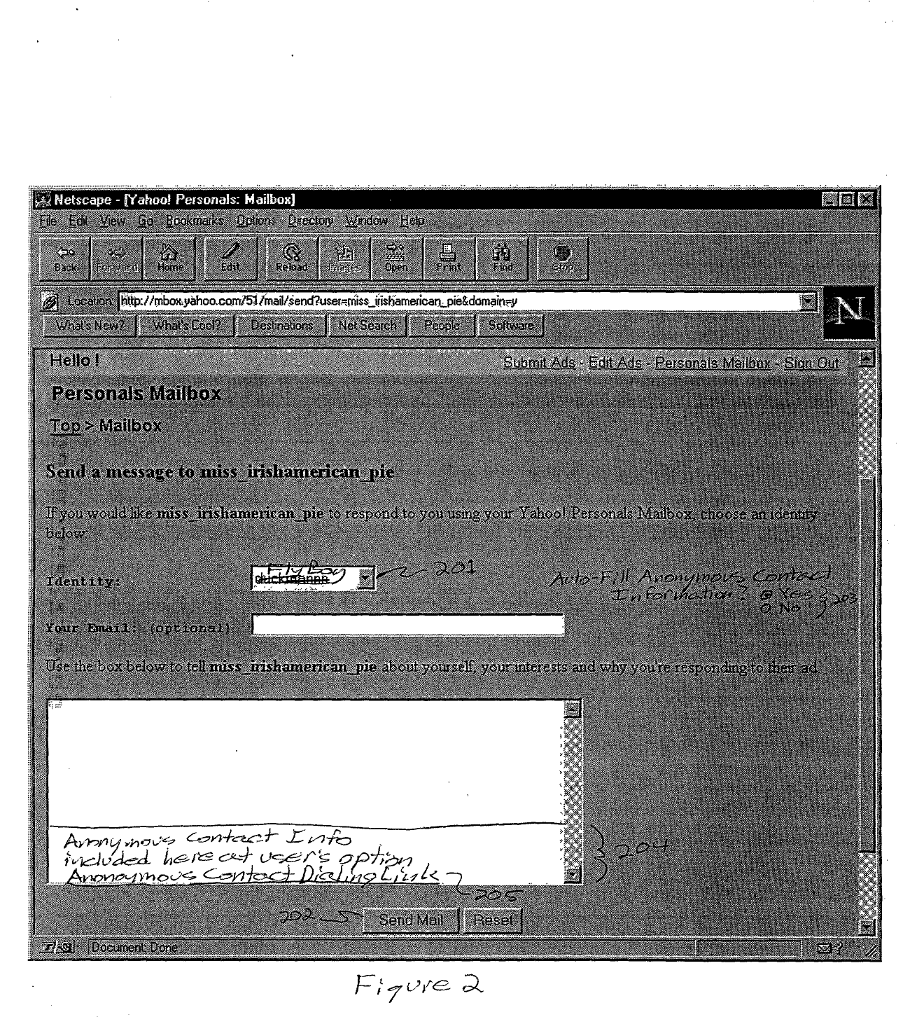

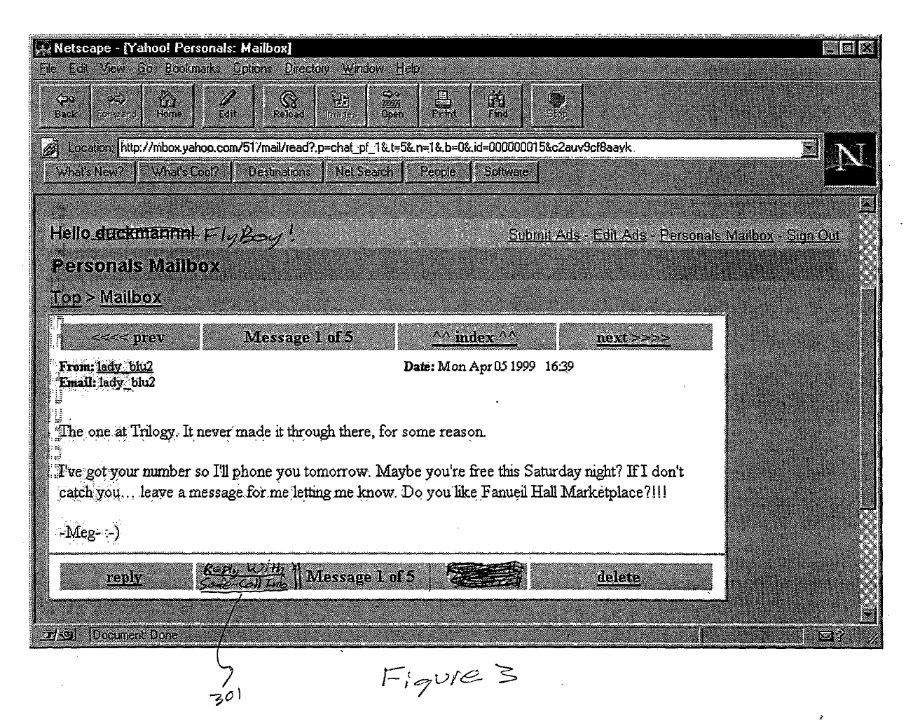

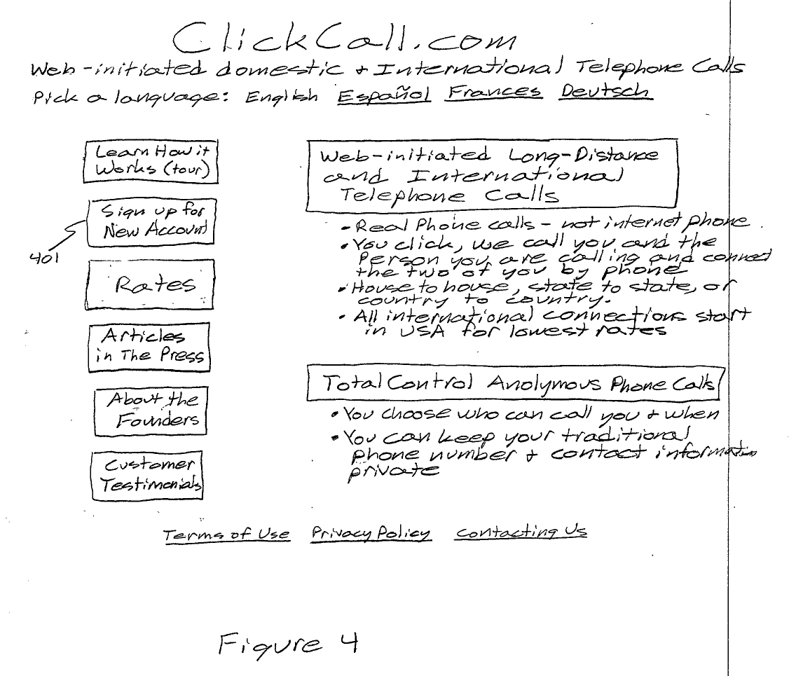

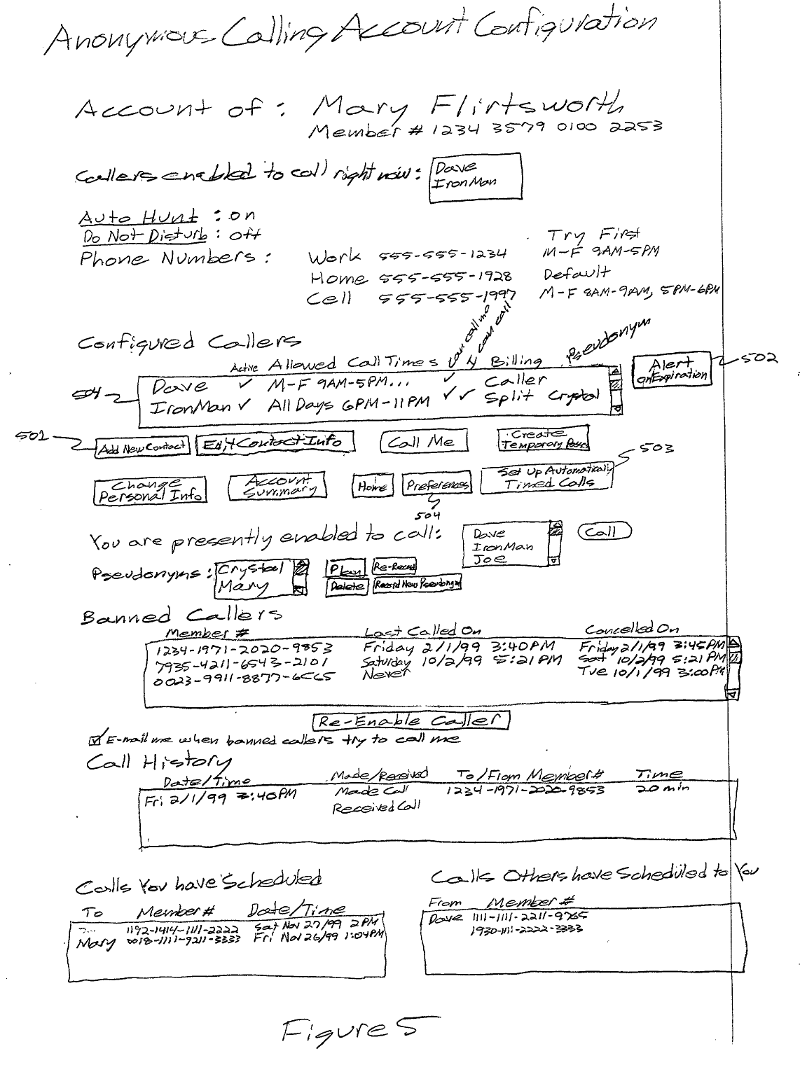

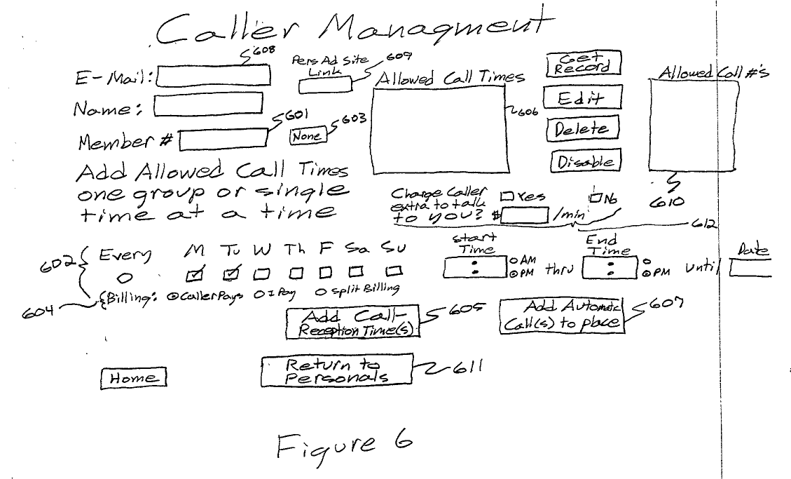

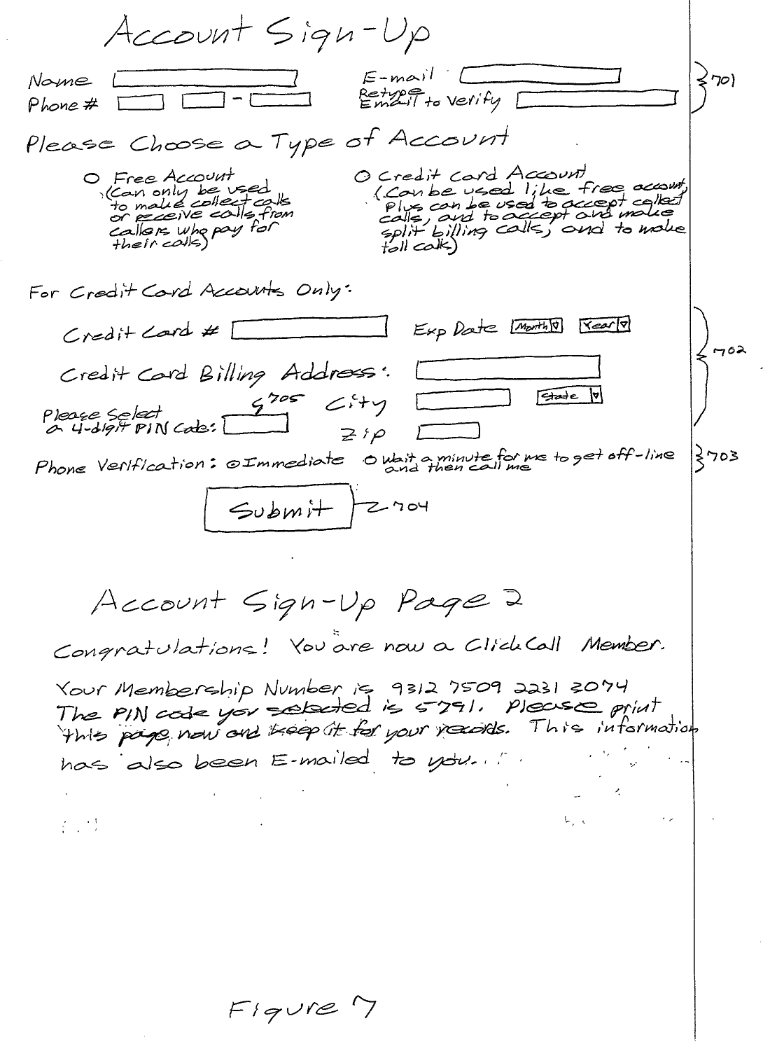

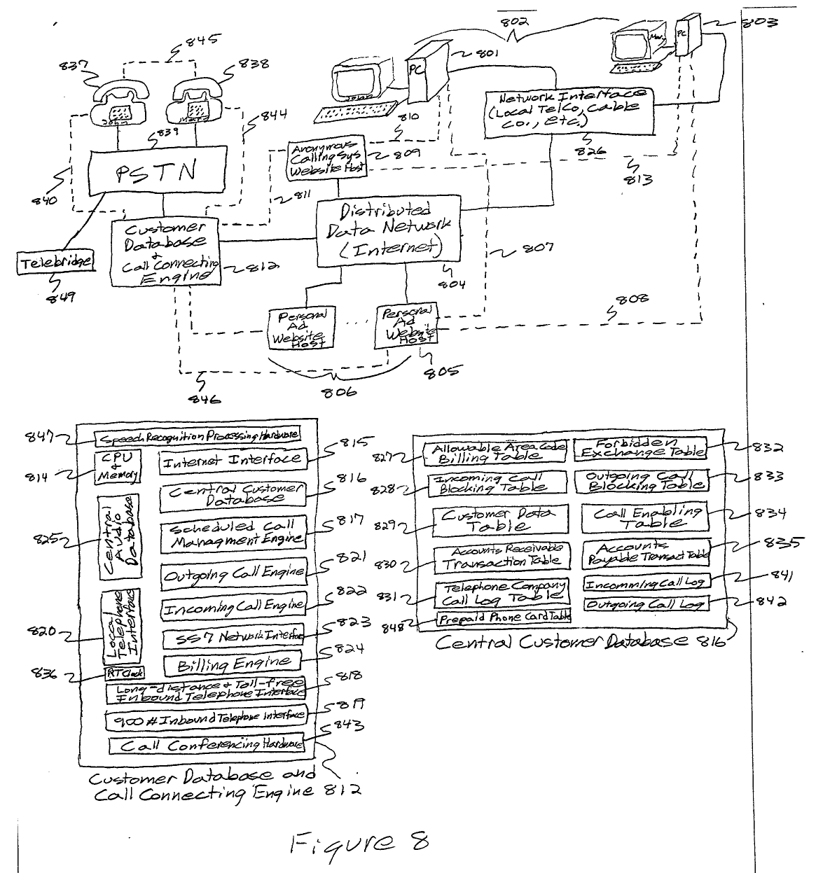

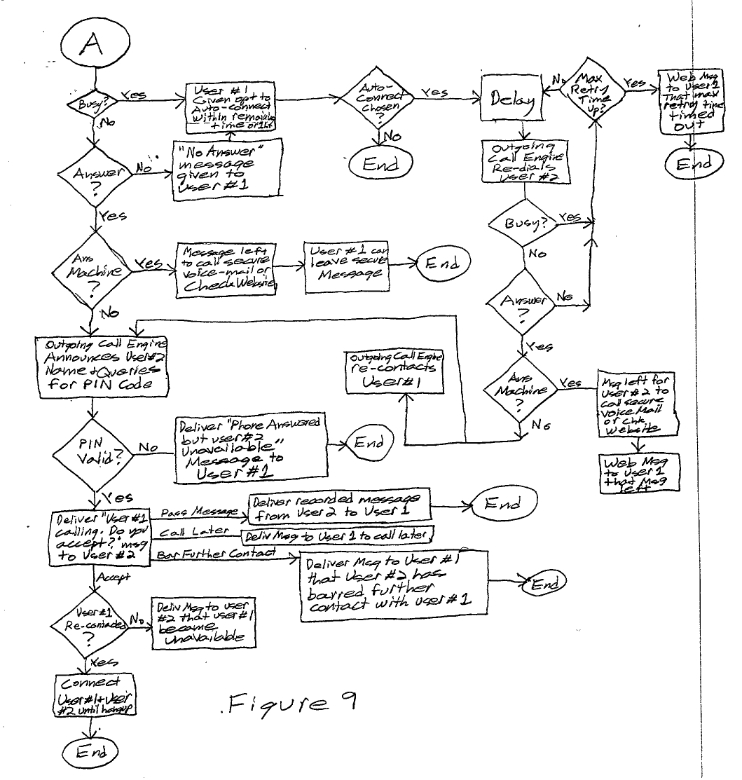

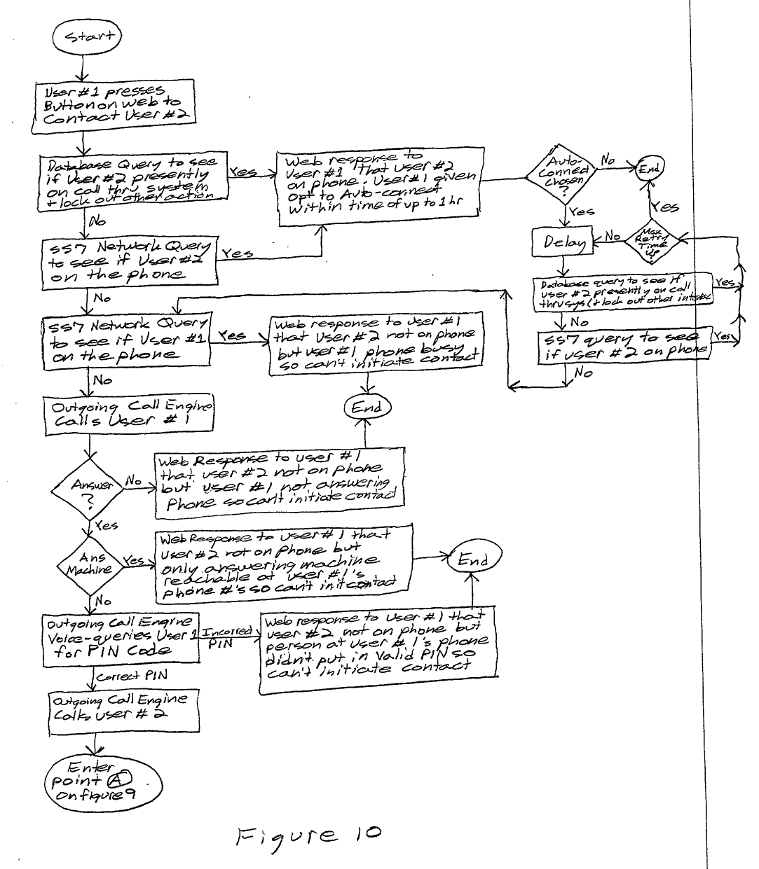

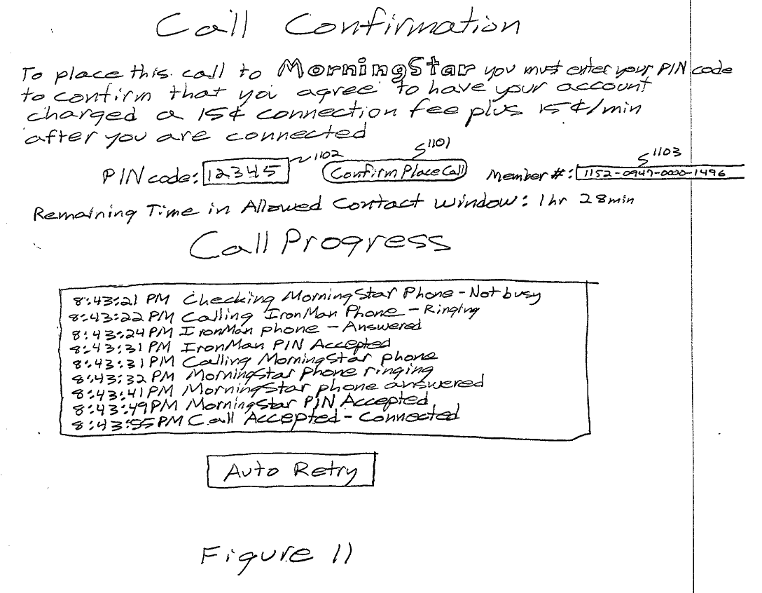

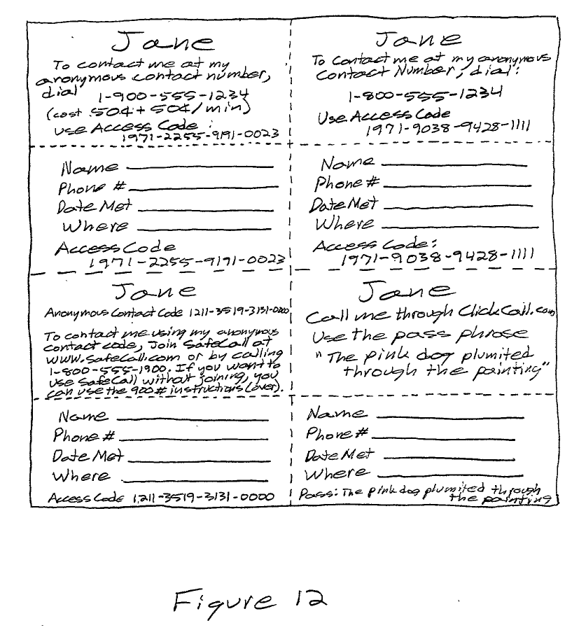

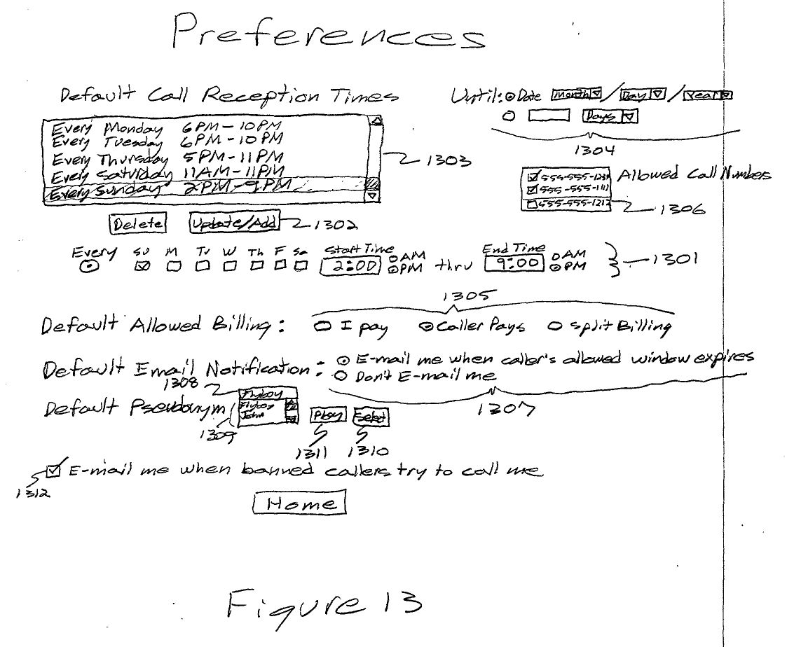

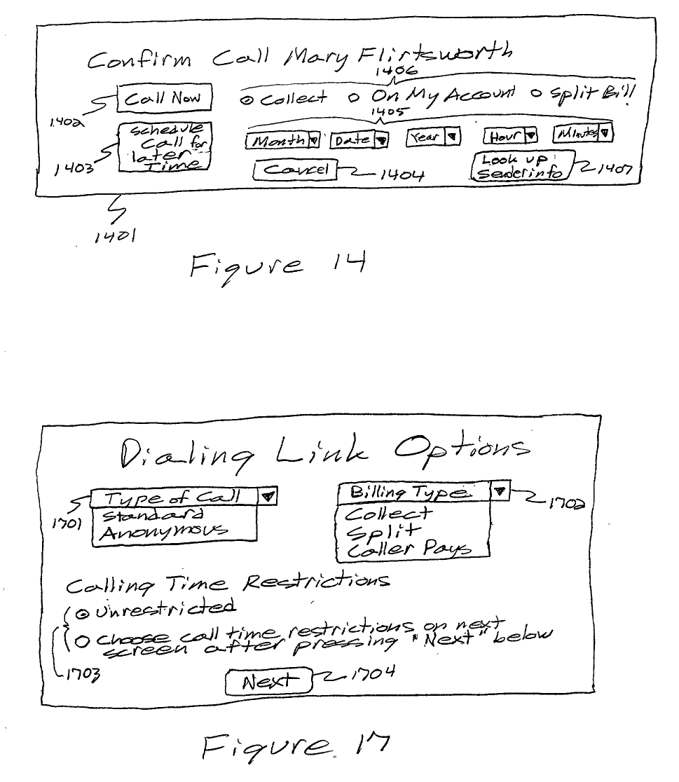

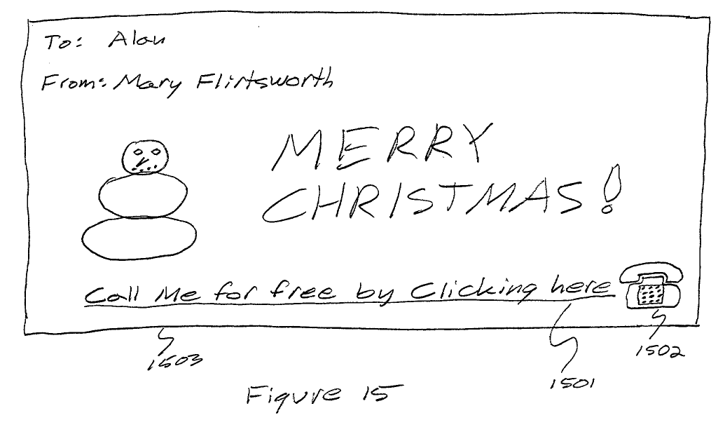

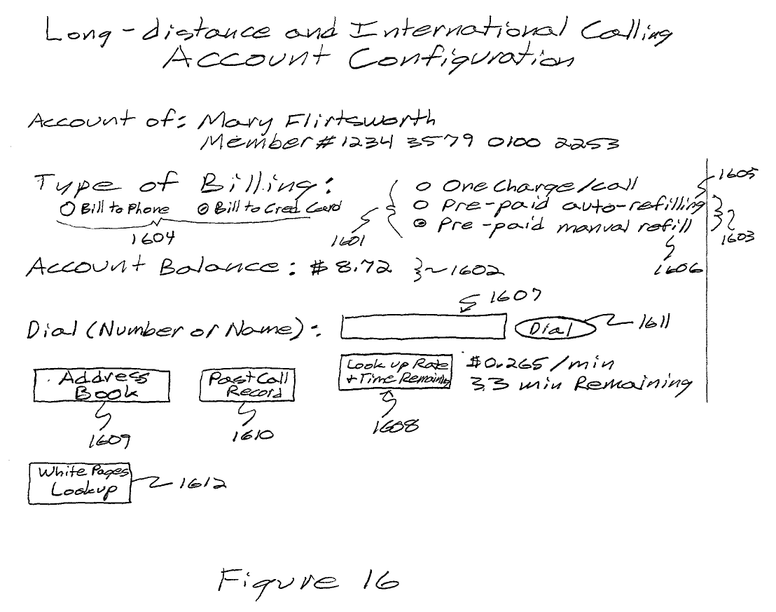

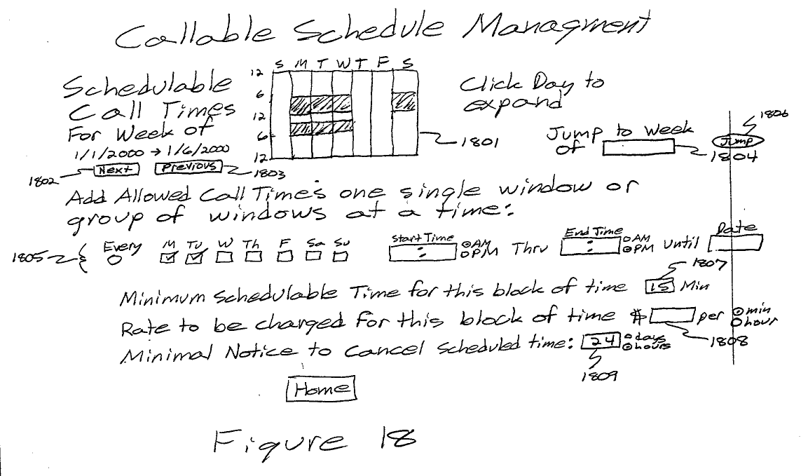

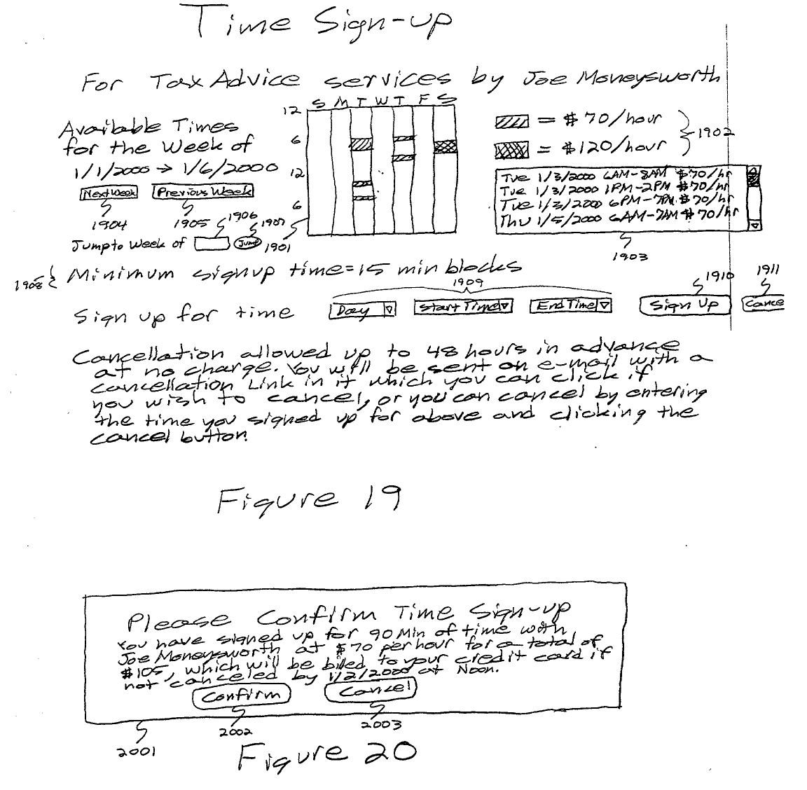

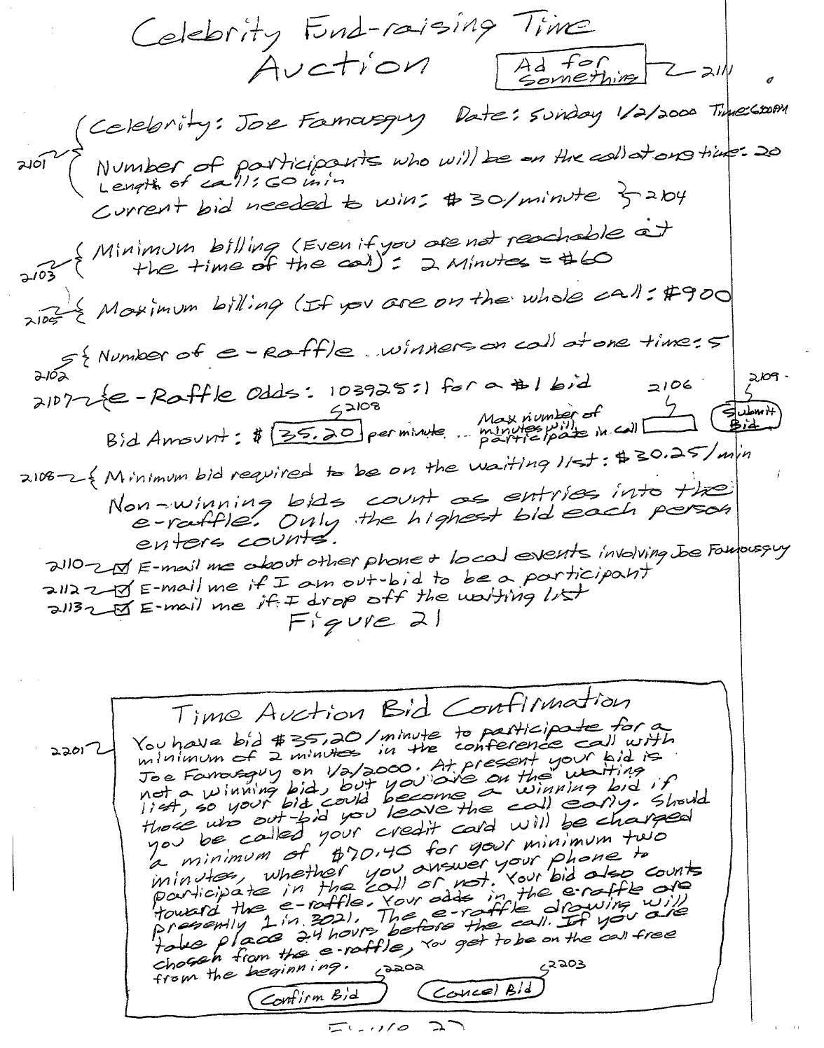

In our first example, let's look at a possible communication between John and Mary, where we assume that Mary is initially a member of the anonymous communication service and John may or may not already be a member. Suppose John is perusing a personal ad website, and comes across an ad like the one shown in FIG. 1, posted by Mary. John reads Mary's ad and decides he would like to meet her, so he opens up a message window such as the one shown in FIG. 2 by clicking on Reply-to-Ad link 101 on Mary's personal ad. John types a message, selects the identity “FlyBoy” from Identity Menu 201, uses Send-Mail button 202 to send his email to Mary.

Normally Mary and John might take a week of calendar time and a couple of hours at the keyboard anonymously emailing back and forth while Mary decides if she thinks John is someone she trusts enough and is interested in enough to give him her phone number, but in this case, Mary decides to cut to the chase using the present invention.

Mary decides to use the present invention to enable John to call her anonymously the next night between 7PM and 9PM. She can set this up semi-automatically or manually. To set it up manually, she accesses her Anonymous-Call account web page (shown in FIG. 5). She clicks Add-New-Contact button 501, and gets the contact management screen shown in FIG. 6. If Mary Knows John has an anonymous calling account and she knows his member number, then she fills in John's membership number in member-number-field 601. (Note that in a preferred embodiment, each member's member number is encrypted differently for each other member, so members cannot become known by a member number to a group of other members. This provides an additional layer of privacy.) After entering John's member number Mary then uses enabled-call-times fields 602 to specify that she will accept calls from John only the next night between 7PM and 9PM, and presses Add-Contact-Time button 605 to log to her account the times John will be able to call her. The allowed contact times for John to call Mary then appear in Allowed-Contact-Times window 606. Since John doesn't have an Anonymous calling account yet, Mary clicks No-Account-Yet button 603, and the system automatically generates a temporary account number for John and fills it in in Member-Number field 601 (at which point Member-Number field 601 becomes unalterable by Mary). If Mary isn't willing to pay for the call when John calls her, she selects the “Caller Pays” option from billing options 604. If she is magnanimous, she can configure billing options 604 to allow John to call her collect. If she likes financial equality, she can check the Split Billing option.

Mary returns to the Account Management screen shown in FIG. 5, and clicks Alert button 502 next to John's name to send herself an automatic e-mail reminding her when the window of time she set for John to contact her has passed and John has become an inactive contact.

Mary then sends a response e-mail to John under her pseudonym through the personal ad website on which she posted her ad. To do this, Mary fills out the same type of web form John filled in to e-mail her (shown in FIG. 2). Her e-mail tells John that she would like to talk to him on the phone the next night, and he should sign up for an anonymous calling account and call her at the temporary calling number she has given him. She clicks on Auto-Fill button 203, and the schedule of times John is allowed to call her, along with a temporary account number for John to use to contact Mary for the first time, and instructions on how to sign up for an Anonymous calling number are automatically appended to the end of Mary's e-mail to John.

Mary can choose a more automated method for replying to John and setting up his allowed call times. The automated method can save a lot of time if Mary has filled in default preferences in her preferences page (shown in FIG. 13). Mary only needs to fill in her preferences one time and they will thereafter be available for automatic use. To fill in her preferences the first time, Mary goes to her Preferences web page by clicking preferences button 504 on her account configuration page. Mary then fills in one or more default allowed contact time windows, using time window inputs 1301, and pressing Update/Add button 1302 to add each default contact window to Default Call Reception Time List 1303. Expiration Date 1304 may optionally be specified to terminate repeated allowed contact times. If Mary specifies Expiration Date 1304, she may use Default Automatic Notification option 1307 to automatically send herself an e-mail reminding her when the set of allowed call times she has set up for a given caller have expired.

By selecting the I Pay option from Default Allowed Billing Options 1305, Mary can specify that it will be the option of the caller whether Mary pays or the caller pays. By selecting the Caller Pays option from Default Allowed Billing options 1305, Mary can specify that the caller always pays. By selecting the Split Billing option from Default Allowed Billing options 1305, Mary allows the caller the option of choosing whether the caller pays for all of the call, or splits the bill with Mary. Mary can check off as many of her phone numbers as she likes in Default Allowed Call Numbers window 1306.

When choosing a default pseudonym from pseudonym list 1309, Mary can listen to the recordings she has made of these pseudonyms by clicking on a pseudonym and then clicking Play button 1311. To select a pseudonym as her default, she selects the pseudonym from list 1309 and clicks select button 1310.

If Mary wants automatic e-mail notification when a caller's allowed call times have all expired, she can select automatic e-mail notification from notification options 1307. If Mary would like automatic e-mail notification whenever a banned caller tries to call her, she can check Banned Attempt Notification checkbox 1312.

To set up John's contact times in an automated way after she has set up her preferences, Mary clicks Reply With Safe Call Info link 301 on John's e-mail, and is immediately brought to the caller management screen shown in FIG. 6, where information about John that is known from his e-mail (including his E-Mail Address 608 on the dating website, and the URL 609 of the dating website his communication came from) has already been filled in. If John is already a member of the anonymous calling service, his real membership number will already be filled in. If John is not yet a member of the service, a temporary membership number will already be filled in in Member Number Blank 601. Mary's default call time window preferences will already be shown in Allowed Call Times window 606, and the default phone numbers the system can use to reach her at those times will already be filled in in Allowed Call Numbers window 610. Mary can choose to modify some of the defaults she loaded for John, or she can just click Return To Personals button 611 to return to John's response to her personal ad. When she returns to John's personal ad, she returns to a response window (see FIG. 2) like the one John used to respond to her personal ad. Because Mary used the automatic features above, information on the anonymous contact times she has set up for John is included at the end of her response automatically in Anonymous Contact Information Area 204. Included in this anonymous contact information is Anonymous Contact Dialing Link 205, which, if clicked by John during the allowed contact time window Mary has defined, will connect John and Mary live by phone.

John receives Mary's e-mail and is excited that she wants to talk to him on the phone. In one preferred embodiment, the detailed instructions for contacting Mary are included in the e-mail John receives. In an alternate preferred embodiment, John is simply instructed to contact Mary by clicking a link in the e-mail. When John clicks the link, if he is not already a member, he is automatically given instructions how to sign up for an anonymous calling account. If Mary allows collect calls, John is given the option of signing up for a free account. If Mary has not enabled collect calls, John will be instructed in the sign-up process that he must provide billing information (such as credit card information) in order to be able to contact Mary.

After John has signed up, clicking the link Mary provided will bring John to a confirmation/option page such as shown in FIG. 14. This page allows John to confirm that he wants to call Mary right now. It also allows John to jump to his anonymous calling account and configure scheduled calls to Mary or allowed times for Mary to call him.

If John were signing up without having received a link from Mary, he would start on the Anonymous Calling home page in FIG. 4, and click Account Sign-up Button 401 to access the New Account Sign-up web page shown in FIG. 7. Because John started with the link from Mary, he automatically winds up on the new account sign-up page and his account number has already been filled in from the link provided by Mary. John fills in Personal Information 701 and Billing Information 702, and chooses a PIN code 705. John chooses the “immediate” option from Phone Verification options 703 and presses Submit button 704. John's credit card information is verified immediately and his phone rings and he answers it. An automated interface asks him to enter his PIN code to verify that he authorizes Anonymous calls to be sent to that phone. John enters his PIN code and is told by the automated voice interface that in order to finish setting up his account, he needs to record his own name (to be used as a greeting to him when he gets anonymous calls). He is told that this greeting he records will not be played to people he calls, so there is no danger of him loosing his anonymity, and he should use his real name, so that if anyone in his household besides him answers the phone, they will hear his name in his voice, and will call him to the phone rather than hanging up thinking it's some automated marketing call. John is prompted to record his name at the tone, and then given a chance to listen to it, and re-record if he is not satisfied.

Next, John is given the option to record an initial pseudonym if he wishes (to be used to announce to those he anonymously calls who is calling), and it is suggested that he might want that pseudonym match a pseudonym he uses in personal ads. John records the pseudonym “FlyBoy”, which is the pseudonym he has been communicating to Mary under. John is told that he can return to his account management page at any time to record further pseudonyms or alter what pseudonyms are used for calling the different people he calls through the system. John is then told that his account setup is complete, and he has been sent an e-mail with all the information he will need to use the system.

When John finishes the account sign-up, he is automatically taken to a web page asking him is he would like to schedule an automatic call to Mary at the time his allowed contact window starts, so he won't have to remember when to call her. It is explained to John that if he sets up an automatic call, he will be called first, and if he answers, Mary will be called and connected to him. John decides the automatic feature will make him look very prompt and reliable, so he decides to use it.

John is then taken automatically to a page with a link he can click to automatically set up Mary as someone who is allowed to contact him anonymously. He fills in that Mary is allowed to call him collect, and that she is free to contact him any time of day.

After entering his anonymous call account information, John returns to the personal ad website to send a return email to Mary saying that he will call her the next night at the start of the allowed contact time window she set up for him, and that if she likes, she can call him anonymously toll-free any time.

The next night John receives his call from the system right at the start of the allowed contact time window Mary set up for him. He enters his PIN code at the prompt, and the system calls Mary. The flow of events for an anonymous call are shown in the flow diagram in FIG. 9.

Mary is sitting at home, eating an egg salad sandwich and watching Ally McBeal, and her phone rings. She answers, and hears her own voice say “Mary”, and then the automated interface voice says “you have an incoming Safety Call. To hear who your call is from, please enter your PIN code.” Mary enters her PIN code. The automated interface then says “you have a call from”, and then she hears John's voice say “FlyBoy”. The announcer's voice then continues “this is your first call from a member at this caller's phone number”. The automated interface continues “To take this call now, press 1 and say hello. To reject this call and disable call reception from ‘FlyBoy’, press 2. For further options, press 3.” Mary presses 1, John hears her say hello, and they begin talking (and John's credit card account begins being billed).

If John had called Mary anonymously before, then when Mary entered her PIN code, she might have heard “You have a call from FlyBoy. The last time you got a safe-call from a member at this caller's phone number was Wednesday at 9:07PM.” The announcement of the last time a caller called is intended to give the call recipient additional information about who is calling. This might be useful, for instance, if Mary had decided she didn't want to speak to John any more, but he called back under a different pseudonym and she hadn't yet gotten around to disabling him as a caller. Mary has two ways she can disable John from contacting her through the anonymous calling system. She can go to her account page at the website and select and disable John as a contact there, or she can disable John as a contact any time she has an incoming call from him, before being connected to him on that call. In an alternate preferred embodiment, she can also disable John as a contact during an anonymous call with John, by pressing a sequence of numbers on her phone while she is on the line with John.

In a preferred embodiment, if Mary has enabled John to call her and John places an anonymous call to Mary and she doesn't take the call or isn't home, John has the option of leaving an secure (PIN-code-protected) voice mail for Mary. Mary can choose to be notified of secure voice mails through a message left in her non-secure voice mail, or she may choose to be notified through an e-mail, or both. Mary can pick up her secure voice mail by dialing in through inbound toll-free interface 818. In a preferred embodiment, there is a charge for secure messages. Either the caller who leaves the secure message or the recipient who picks up the secure message can pay for the message. Thus if Mary has a free account, she can only receive messages from callers who are willing to pay to leave the message. If a free member of the service tries to call or leave a message for another free member of the service, the calling member will be instructed that he or she must be a paying member to leave a message for that member.

John and Mary can communicate through the anonymous calling interface for as long as they are both happy doing so and at least one of them wishes to remain anonymous. If they decide they like each other and they want to meet, they can arrange to meet somewhere and still remain anonymous if they like. It is totally up to them if they ever want to exchange non-anonymous contact information. If Mary decides after some phone calls that she doesn't want to hear from John any more, she can deactivate him on her anonymous contact list (or delete him from it).

After his first call with Mary, John is perusing the personal ads and sees an ad from Beth, who he decides sounds interesting. He notices that the Available-To-Be-Called-Now” icon 102 next to Beth's personal ad is lit up. John clicks the icon, and gets a confirmation screen such as the one shown in FIG. 11, asking him to confirm that he wants to initiate an anonymous phone call to this person who has at the moment enabled anyone to call her. John sees the rate that he will be billed is the normal rate, so he decides to continue with the call by entering his PIN code in PIN-Code-Field 1102 and clicking Place-Call button 1101. If John was not on his own computer he would also have to enter his member number in Member-Number-Field 1103, but if he is on his own computer, this information has been filled in for him automatically. After John presses Place-Call button 1101, the system checks to see if Beth's line is free and John's line is free. If both are free, the system makes Beth's line look busy to everyone else on the anonymous calling system except John, and the system calls John. John enters his PIN code. John has never called Beth before, so there is no pseudonym on file for use in calling Beth, so John is prompted to record pseudonym for his call to Beth. John can choose to use with Beth one of the pseudonyms he has recorded for other people in the past, or he can record a new pseudonym, or he can choose to use no pseudonym (in which case the system announces him to Beth by his ID number). John decides that being announced by his ID number would be pretty lame, and he thinks the pseudonym “FlyBoy” is too intense to use with Beth, so he records a new pseudonym. John's call then goes through to Beth in the usual manner.

John has a nice conversation with Beth, and she adds him to her Enabled Caller list 504, and e-mails him to check his account management page to see the times he is enabled to call her.

John checks and sees that Beth has enabled him to call her Tuesday night between 8PM and 9PM. He decides he likes the scheduled calling feature, so he clicks Set-Up-Automatic-Timed-Calls button 503 to schedule some automatic calls to Beth. He is taken to a contact management page (for his contacts with Beth), such as that shown in FIG. 6. He fills in “Tuesday at 8:15PM” in Time-and-Date fields 602, and presses Add-Automatic-Calls-To-Place button 607. He then emails Beth that he will call her at 8:15PM on Tuesday. When Tuesday night rolls around, John doesn't have to remember to call Beth, he just has to be reachable at one of his phone numbers. The system takes care of making sure John places his call on time as he told Beth he would. When the call time arrives, the system calls John first, and the call to Beth is initiated after John verifies who he is by putting in his PIN code.

John also decides he isn't sure where he will be on Tuesday night when it's time to call Beth, so he enables the “Hunt” feature on his account, he specifies that Between 9AM and 5PM he wants to be called at work first, and at other times he wants to be called at home first. If he is not reached on the first call, he specifies that the system should try his cell phone second, and his other number (work or home) third. For each phone John can be called at by the system, he can specify whether a message should be left if the system can not locate him at any of his numbers. The system will first try John at each of his specified numbers, and if it does not reach him (i.e. if no correct PIN code is entered), it will then call the numbers John has specified for messages, and leave a message for John at each of those numbers. In a preferred embodiment, the message left for John will instruct him to call a toll-free number and enter his PIN code. When John gets his message and calls, he will be given a voice message describing the time and person to whom he set up the scheduled call he missed. He will then be given the option of initiating that call immediately, or rescheduling it if the allowed contact time window for the person he is calling has passed.

Customers who wish only to receive calls (or make calls where the called party has enabled them to call with the charges being paid by the called party) can sign up for an anonymous calling number without giving credit card or other billing information.

In a preferred embodiment call recipients can choose to charge anonymous callers who contact them an extra per-minute fee (above and beyond the regular per-minute contact charges). Thus, erotic phone services and the like can be billed through the system. This method of delivering erotic phone services has a distinct advantage over 900 numbers and the like, because the person delivering the service can choose the hours they will be available, can choose to ban obnoxious callers from calling again, and can choose to give preferred customers better rates. In addition, delivery of such services makes it easy to set different rates for different times of the day. The person delivering the erotic service can elect to be available only at certain times of the day, and those times will automatically be visible to customers over the web.

### DETAILED DESCRIPTION OF ANONYMOUS CONNECTION SYSTEM OPERATION

A block diagram showing the major functional blocks and the relevant data paths of the present invention is shown in FIG. 8. A flow diagram showing the placing of an anonymous call initiated over the web is shown in FIGS. 8 and 9.

When John first reads Mary's personal ad, he does so over PC (Personal Computer) 801, which is one of a plurality of personal computers 802 which may be connected to a Distributed Data Network (such as the internet) 804, normally via an intermediate Network Interface 826, such as a local telephone company, cable company, etc. Mary's personal ad is delivered to John by Personal Ad Website Host 805 (which is part of a plurality of personal ad website hosts 806). John's initial retrieval of Mary's personal ad, and his response to that ad take place over data path 807 through Internet 804. John's response to Mary's personal ad is held in Personal Ad Website Host 805 until such time as Mary accesses Personal Ad Website Host 805 through PC 803, retrieving John's e-mail response via data path 808. Mary's response e-mail is sent back to John by first being stored at Personal Ad Website Host 805, and then being retrieved by John via data path 807 when he next accesses Personal Ad Website Host 805.

John connects to Anonymous Calling Website Host 809 via Internet 804 along data path 810, and fills out the forms to sign up for anonymous calling service. When John electronically submits his sign-up forms, his information is sent to Customer Database & Calling Engine 812. In one preferred embodiment, Anonymous Calling Website Host 809 and Customer Database & Call Connecting Engine 812 are not located in the same place, and data path 811 may route through Internet 804. In another preferred embodiment, Anonymous Calling Website Host 809 and Customer Database & Calling Engine 812 may be connected by a local network or may even reside on the same computer.

In a preferred embodiment, Customer Database & Call connecting Engine 812 comprises hardware components including CPU & Memory 814 (such as a dual Pentium 400 CPU with 256 MB of RAM and dual sets of two mirrored 20 GB SCSI Ultra II Hard Disks), Internet Interface 815, Long-Distance Toll-Free Inbound Telephone Interface 818, 900# Inbound Telephone Interface 819, Local Telephone Interface 820, SS7 Network Interface 823, Real-Time Clock 836, Speech Recognition Processing Hardware 847; and software components including Central Customer Database 816 (implemented on a platform such as Microsoft SQL Server 7.0 running under Windows NT 4.0), Scheduled Call Management Engine 817, Outgoing Call Engine 821 comprising dialing means for initiating a plurality of outbound telephone calls, Incoming Call Engine 822, Billing Engine 824, And Central Audio Database 825 (comprising tables in a database platform such as SQL 7.0 and a referenced audio files such as “.wav” files, or compressed audio files such as “.mp3” files or the like).

When Mary enables John to call her, she does so through her PC 803 by accessing Anonymous Calling Website Host 809 via data path 813. Data Mary types in specifying when John can contact her is communicated to Customer Database and Call Connecting Engine 812 via Distributed Data Network 804 (such as the Internet) over data path 811, creating entries in central Customer Database 816. Central Customer Database 816 comprises Allowable Area Code Billing Table 827, Incoming Call Blocking Table 828, Customer Data Table 829, Accounts Receivable Transaction Table 830, Telephone Company Call Log Table 831, Forbidden Exchange Table 832, Outgoing Call Blocking Table 834, Accounts Payable Transaction Table 835, Incoming Call Log 841, and Outgoing Call Log 842. When Mary sets up a time when John can call her, John is added to her record in Customer Data Table 829, and a record for the time window for which John is allowed to call Mary is added to Call Enabling Table 834.

When John signs up for an anonymous calling account through Anonymous Calling Website Host 809, a record is created for him in Customer Data Table 829. When he enters the temporary membership number he gets in Mary's e-mail, that temporary membership number is matched with entries Mary made in her record in Customer Data Table 829 and Call Enabling Table 834, and John's temporary membership number is replaced in these two records. In a preferred embodiment, John's temporary membership number is replaced in John's record with his newly assigned permanent membership number, and the temporary number in Mary's record is replaced with an encrypted version of John's membership number which she can always use to identify John, but which would not work for someone else to try to contact John with if she gave it to someone else. John may in fact have numerous temporary membership numbers when he signs up for full membership, and all of his temporary membership numbers will be replaced with his permanent membership number.

When John signs up for an anonymous calling account, it is desirable for the system to verify that calls for John will indeed be accepted at the phone numbers John has supplied. (It would not be desirable for hackers to be able to set a third party up to receive anonymous calls without the permission of the third party.) To verify that calls will be accepted for John at the numbers he supplies, as part of the sign-up process (or whenever John adds a new phone number for himself to his account), Outgoing Call Engine 821 calls John at the number he supplies, via Local Telephone Interface 820 or Long-Distance Telephone Interface 818. John Receives the call on his telephone 837 via the Public Switched Telephone Network (PSTN) 839, over data path 840. John responds appropriately (via voice response or touch-tone response) to voice inquiries from Outgoing Call Engine 821, and his phone number is validated.

If john wants to initiate a call to Mary without using the Internet (during the time window she has allowed herself to be contacted by him), he first calls Call Connecting Engine 812 via Local Telephone Interface 820 or Long-Distance and Toll-Free Inbound Telephone Interface 819. When John's call is received, Incoming Call Engine 822 makes an entry in Incoming Call Log 841.

Incoming Call Engine 822 then checks to see that the number John is calling from is not in Incoming Call Blocking Table 828 (used to refuse calls from phones which have tried hacking the system in the past). If John's number is not blocked, and John is calling from his own phone, Incoming Call Engine 822 recognizes his caller ID number and simply asks John for his PIN code. If John calls from a phone other than his own, then in addition to his PIN code, Incoming Call Engine 822 will prompt John for either his home phone number or his membership number.

Any valid or invalid account-identifying information entered by John is logged by Incoming Call Engine 822 in Incoming Call Log 841. Analysis may be done on Incoming Call Log 841 to determine patterns of attempted hacking, and to appropriately block call reception from certain numbers by Call Connecting Engine 812.

After verifying that John's number is not blocked and John has a valid account, Incoming Call Engine 822 queries Call Enabling Table 834 in Central Customer Database 816, to see if any entry there for John has calling enabled at the present time. If it does, then John may be given a voice menu of the names of people he is presently allowed to contact. In an alternate preferred embodiment, John may be asked to enter the membership number of the party he is calling. Once John chooses to call Mary, an entry is made in Outgoing Call Log 842, indicating the time and destination of John's call. Outgoing Call Engine 821 then calls Mary's number. If a connection is made, the connection is noted in Outgoing Call Log 842 (to be used for billing purposes). If Mary's phone is busy, that is also noted in Outgoing Call Log 842, and John is given the option of being called automatically if Mary's phone becomes free within his allowable contact period (John may be billed extra for this option if he selects it).

In a first preferred embodiment, if Mary is home when she is called by Outgoing Call Engine 821 on behalf of John, and she chooses to accept the call from John, then Call Conferencing Hardware 843 connects John's incoming call and the outgoing call to Mary, under direction of Outgoing Call Engine 821 (such that John and Mary are connected by data paths 840 and 844). In an second preferred embodiment, after Mary chooses to accept John's call, she hangs up, and SS7 Network Interface 823 routes John's call directly to Mary via data path 845, populating the Caller ID data with the phone number of the anonymous calling service, so that John's number is not given to Mary unless he wants to give it to her. In a third preferred embodiment, Mary need not hang up, and SS7 network interface 823 transfers John's call directly to Mary. In the first preferred embodiment, billing is calculated by the differences in the time entries in Outgoing Call Log 842 between when Mary was contacted and when she hung up. In the second and third preferred embodiments, billing is calculated by correlating telephone company billing entries in Telephone Company Call Log Table 831 (obtained from the telephone company and stored locally) with entries in Outgoing Call Log 842. The second and third preferred embodiments have the advantage that they tie up no phone lines at Call Connecting Engine 812 except during the setup phase of each anonymous call. The second and third preferred embodiments also have the second advantage that they cost less for the portion of the call when John is directly connected to Mary.

If John were to be on line to Personal Ad Website Host 805, and saw a personal ad (such as shown in FIG. 1) that indicated that Jane was open to receiving calls from all users of the website, and John clicked Call Button 103 on the website to call Jane, that would initiate a data communication between Personal Ad Website Host 805 and Customer Database & Call Connecting Engine 812 via data path 846 to find out whether Jane's phone is presently available to be called. In a first preferred embodiment, Customer Database 816 is queried to find out whether there is presently an active anonymous call connected to Jane. If there is not, then Jane and John are both called by Outgoing Call Engine 821, and providing both calls are accepted, the two are connected via Call Conferencing Hardware 843. In the second and third preferred embodiments, SS7 Network interface 823 is used to connect John and Jane through PSTN 839.

### DETAILED DESCRIPTION OF WEB-INITIATED NON-ANONYMOUS PHONE CALLS

Hundreds of millions of on-line greeting cards were sent in 1999, through on-line greeting card services such as those provided by companies such as Yahoo, and BlueMountain.com. Suppose Mary hasn't heard from her friend Alan for a long time, so she sends him an on-line greeting card from an on-line greeting card company which offers links through the present invention. When Mary sends Alan the on-line greeting card, she can choose the type of dialing link she would like contained within the card. FIG. 17 shows an example web page on which Mary might choose the dialing characteristics of the dialing link she includes in her card to Alan. Type of Call Menu 1701 allows Mary to select between a standard type of call (which she picks because she and Alan are old friends) and an anonymous call (which she might use to send a card to a guy she was getting to know through e-mail). Billing Type Menu 1702 allows Mary to send a collect call link (in which case Alan could choose to call her at her expense, his expense, or split the cost), a split call link (in which case Alan can choose between calling her with split billing, or at his expense), and Caller Pays billing, in which case Alan must pay for the call. Calling Time Restrictions Options 1703 allows Mary to select whether Alan can call her any time (unrestricted), or only at certain times. If she selects to restrict the times when Alan can call her, she must fill in an additional screen after pressing Next button 1704. The call time restriction screen Mary may choose to fill in provides features like the caller management web page shown in FIG. 6, allowing her to choose a single time window or a repeating set of time windows in which Alan may call her. It also allows her to choose an expiration date for the calling link she sends Alan. Alternate embodiments might also allow Mary to choose a limit to the amount of money she will spend on a particular call.

As with most on-line greeting cards, Alan receives an email telling him he has an on-line greeting card. The e-mail contains a hyper-link that he can click to access the web page which is his personalized on-line greeting card. Alan clicks the link in his e-mail and gets the web page which is his on-line greeting card, shown in FIG. 15. The on-line greeting card 1503 contains Dialing Hyperlink 1501 and Dialing Icon 1502. If Alan clicks Dialing Hyperlink 1501 or Dialing Icon 1502, he gets Dialing Confirmation Dialog Box 1401 (shown in FIG. 14).

Dialing Confirmation Box 1401 gives Alan the choice between confirming that he wants to make the call to Mary immediately (by clicking Call Now button 1402), scheduling the call to take place automatically at a later time (by filling in date and time fields 1405 and pressing Schedule Later button 1403), or canceling the dialing transaction by pressing Cancel button 1404. If Alan chooses to dial the call now or schedule it for later, he can use billing selection buttons 1406 to choose whether he wants to call Mary collect, split the charges, or foot the bill himself.

Since Mary sent Alan a standard (not anonymous) calling link, he can press Look Up Sender Info button 1407 to look up Mary's phone number and address (as well as any time restrictions on the dialing link she sent him). If Alan was receiving an electronic greeting card with an anonymous calling link, then pressing Look Up Sender Info button 1407 would only provide Mary's member number (which in a preferred embodiment has been individually encrypted for Alan so he can't pass it on to anyone), the pseudonym she uses with Alan, and any call time restrictions she placed on the dialing link she sent Alan.

If Alan tries to use the dialing link to call Mary at a time outside the time window she specified for the dialing link, he gets a dialog box telling him the time restrictions on the dialing link, and offering him the option of scheduling the call to take place during the allowed dialing time.

An account configuration web page for managing non-anonymous web-initiated phone calls is shown in FIG. 16. Customers may choose how they want to be billed by selecting from Billing Options 1601 and billing types 1604. In a preferred embodiment, if customers choose to be billed once per call, they may always maintain an account balance of zero, but they will pay an extra charge (to cover the cost of the credit card or other financial transaction) for each call. If customers select one of prepaid billing options 1603, they get a lower effective rate, because the minimum amount billed to their credit card (or phone bill if they select to be billed on their phone bill instead of a credit card) is the pre-paid amount, which might be (for instance) $10 or $20. If the customer selects Auto-refilling option 1605, then they are automatically billed at least the minimum billing increment every time their account falls below a minimum balance. If they select Manual Refilling option 1606, then they are cut off on the phone when their account reaches zero balance, and they are sent an e-mail with instructions to go to the website and authorize payment to refill their account.

Account balance 1602 shows how much money remains of the most recent amount that has been pre-paid (under pre-paid options 1603).

### DETAILED DESCRIPTION OF USE IN LONG-DISTANCE AND OVERSEAS PHONE CALLS

The present invention may be used as an supplemental long-distance service. Supplemental long-distance services which require the customer to dial an access code are well known in the art. Pre-paid calling cards are examples of supplemental long-distance services. These cards may offer long-distance rates or overseas rates lower than a customer's “one-plus” long-distance provider. Some supplemental long-distance services may be accessed from a customer's home phone by dialing a five-digit prefix and then dialing the number being called. These types of supplemental services are billed through the local phone company. Other supplemental long-distance services (such as most pre-paid phone cards) require the customer to dial an access number and a long PIN code as well as the number being dialed. These services often require a customer to dial about 30 digits (without making a mistake) to make a call.

The present invention allows customers to make long-distance calls with a single click to any number they have set up in their on-line dialing address book. Customers may enter the phone number they wish to dial in Dialing Field 1607, and click Rate Lookup button 1608 to look up how long they could talk on the money presently in their account, and what per-minute rate they would be charged. A user-defined alias may be typed into Dialing Field 1607 in place of a phone number. Dialing is initiated by clicking Dial button 1611. Users may define aliases in an address book, which may be accesses through Address Book button 1609. Past calls made through the system may be perused by clicking Past Call Record button 1610. White pages lookup button 1612 allows customers to look up phone numbers and transfer them into their address books.

When customers make phone calls, the calling and called parties are both called by outbound call engine 821. Thus, calls to both parties are incoming calls (from the point of view of the people being called). This allows the present invention to provide overseas phone calls at bargain rates anywhere in the world. In many countries, long-distance and overseas phone rates are set by the government, and there is no way to make inexpensive outbound overseas calls. The present invention gets around that limitation because all calls are inbound. For instance, it might cost $2 per minute in Ireland to call Australia, while in the USA it might cost 6 cents per minute to call Ireland and 10 cents per minute to call Australia. Thus, the present invention can source one call from the USA to Ireland, and a second call from the USA to Australia, and connect them together and bill the resultant call at 50 cents per minute, saving the Irish caller 75% while still making 50% profit.

In a preferred embodiment, once both connections have been made, SS7 network interface 823 issues network commands to transfer the connection to the POTS network. When the phone number of either the calling or called party is in the USA, network commands may be issued such that the call is still billed as one call. For international calls where both the calling and called parties phone numbers are outside the USA, it may be cheapest to connect the two parties by bridging two calls from the USA, in which case billing is the sum of these calls' billing rates.

The present invention may be used to re-sell and deliver calls through pre-paid phone cards. Prepaid phone cards are purchased in bulk at a discount and their code numbers are loaded into Prepaid Phone Card table 848. Phone cards from this table are assigned to customers one at a time as their accounts are refilled wither automatically or manually through options 1603. Prepaid phone cards are a convenient method for automatically enforcing the end of phone calls when a customer's account balance runs to zero (as the time on the pre-paid card runs out). For international phone calls, pre-paid phone cards which do not allow two simultaneous calls may be assigned to customers in pairs, and both cards will be used simultaneously to source the two halves of the international phone call (both of which originate in the USA.

For customers who have elected non-refillable billing option 1606, timing software actuates SS7 interface 823 to “tear down” or disconnect any call in progress when the account balance hits zero. Safety timer means may also be provided for accounts with refillable billing options to automatically use SS7 interface 823 to “tear down” or disconnect any call which has been going more than some maximum time (for instance, two hours). This would not be necessary in accounts where the actual calls were made through re-sold pre-paid phone cards (because such calls automatically end when the card runs out).

In all uses for non-anonymous phone calls, it is assumed that all applicable features (such as call blocking lists, etc.) described in conjunction with anonymous phone calls can also be made available for non-anonymous phone calls, though they may not be universally enforceable, since the caller may have alternate means for dialing the non-anonymous number.

### USE IN SCHEDULING AND BILLING FOR OVER-THE-PHONE PROFESSIONAL SERVICES AND CUSTOMER SERVICE

Customers who have set up anonymous contact information for themselves may use the present invention to charge for their time on incoming calls by filling out Professional Services Billing field 612 with the amount per minute they would like to charge for calls coming in from the link they are configuring. This feature offers a less expensive alternative to traditional 900 numbers, and allows people to set different rates for different callers (not possible with 900 numbers). Other features which make this service superior to traditional 900 numbers include the fact that customers can schedule different allowed call reception hours for different callers, and can block troublesome callers from being able to call in the future.

The Professional Services Billing feature allows experts (for instance tax experts, legal experts, computer software application experts, etc.) to charge for their expert advise time on the phone. Their time is automatically billed to the account of the person calling them, at the rate they have posted. A call scheduling feature allows experts to make their schedules available to prospective clients over the web, so that prospective clients can sign up for blocks of the expert's time.

In a preferred embodiment, an expert can define his or her schedulable blocks of time through a data entry interface such as the one shown in FIG. 18. Graphical Schedule 1801 shows a particular week of scheduled time. Next Button 1802 and Previous Button 1803 can be used to view the next and previous weeks, respectively. Jump Date field 1804 and Jump button 1806 may be used to jump to a different week by date specified. Time Window Specifying fields 1805 may be used to specify a single time window or a set of time windows to add to the schedule shown in Graphical Schedule 1801. Minimal Schedulable time field 1807 may be used to specify the minimal blocks of time that customers may sign up for. Rate field 1808 may be used to specify the billing rate for a particular block of time. Thus, different blocks of time on the schedule may be billed at different rates. This feature allows experts to charge, for instance, premium rates for weekends. Cancellation Time Field 1809 allows service providers to set the minimal advanced notice for cancellation of scheduled appointments. Appointments that are missed or canceled after the allowed cancellation time will be billed at the agreed rate. Unlike a regular scheduled phone call, o one needs to remember to call. Both parties are called and connected together at the appropriate time. The system can also be set to enforce end times for calls so that professional services providers can stay on schedule. In a preferred embodiment, an automatic announcement can be set to come on a predetermined time before the end of the call. In another aspect of a preferred embodiment, if the service provider is not available at the agreed upon time, the customer is not billed unless the customer agrees to be billed for partial time and connected to the service provider when the service provider becomes available.

FIG. 19 shows a web page through which a customer might sign up for phone time with an service provider. Shaded regions in Graphical Schedule 1901 depicts time available for purchase. Different shadings 1902 indicate different per-unit costs of different available blocks of time. Scrolling table 1903 gives a more detailed listing of all blocks of time available during the week being viewed. Next Week button 1904 and Previous Week button 1905 may be used to jump to the next and previous weeks, respectively, or a date within another week may be entered into Jump Field 1906, and clicking Jump button 1907 will display the schedule that week. Minimum Time indication 1908 indicates the time-granularity of the schedulable time displayed.

Time sign-up fields 1909 allow the customer to select a span of time to sign up for. Clicking button 1910 causes the display of a confirmation dialog box shown in FIG. 20. Confirmation dialog box 2001 summarizes for the purchaser the time and money commitments he or she is making and the time restrictions on cancellation of the appointment, and allows the customer to either confirm the purchase by clicking Confirm button 2002, or cancel the purchase by clicking Cancel button 2003. If the customer clicks Confirm button 2002, the customer is sent a confirming e-mail reminding the customer of the time signed up for, the phone number the customer will be called at that time, the total amount the customer will be billed, and the latest allowable date to cancel. The e-mail also contains a hyperlink which the customer may click prior to the cancellation deadline to cancel his or her sign-up. The customer may also cancel his or her sign-up by filling in the block of time signed up for in time fields 1909, and clicking Cancel button 1911.

In a preferred embodiment, shaded available time regions on graphical schedule 1901 and entries on Schedule Table 1903 change to reflect newly signed up times. It is possible that two users may download the schedule web page shown in FIG. 19 simultaneously, and attempt to sign-up for overlapping blocks of time. In such a case, the second customer to attempt to sign-up for the time gets an error message telling him or her that another user signed up for part or all of the requested time, and the customer should re-load the schedule and try again.

A group call scheduling feature allows experts to book a conference bridge to host group expert question & answer sessions or teleclasses. In a preferred embodiment, the expert is charged a fixed fee for the teleconference bridge rental, and (in exchange for listing the expert group call on a central website) is charged a fraction of the Incoming billing rate they choose to charge each participant of the group call. In a preferred embodiment, time on group calls is scheduled through an interface similar to the one shown in FIG. 19, only the schedulable a block of time doesn't disappear from Graphical Schedule 1901 and schedule table 1903 until the maximum number of participants allowable on the teleconference have all scheduled that block of time.

In a preferred embodiment, group expert connection (Q&A and Teleclass) calls are set up on publicly accessible telebridge 849. Publicly accessible telebridges are very cheap to rent but have no access limitations. Thus if the phone number of the public telebridge is given out to a group of people who will be participating in a teleclass, some may give the number away to friends, who may access the teleclass for free, and may block paying members from being able to get on the telebridge if all the lines get used up. The present invention solves the security problem of the public telebridge because the number of the telebridge is not given out to participants. Participants are hooked to public telebridge 849 through SS7 network commands after being called by Outgoing Call Engine 821 and entering their PIN codes.

In an alternate preferred embodiment, call conferencing hardware 843 can be used to connect groups for teleclasses or group Q&A calls after each participant is dialed by Outgoing Call Engine 821. This connection method is more hardware-intensive than utilizing Public Telebridge 849 to host the teleclass, but may be desirable if a call moderator needs to have the ability to mute or disconnect individual participants who may be causing a disturbance on the call.

In a preferred embodiment, billing for participants in group expert calls (teleclasses, Q&A sessions, etc.) is computed by assuming that all participants who do not cancel their sign-up for the call within some fixed time before the call are billed for the whole call, whether they actually participate or not. In an alternate preferred embodiment, call participants are only billed for the amount of time they actually participate in the call. This type of billing may be preferable for calls where a waiting list is allowed and where some participants may be admitted to the call as others sign off. If the conferencing is hosted by call conferencing hardware 843 connecting multiple lines of Outbound Call Engine 821, then the Information indicating which participant has hung up is immediately available from Outbound Call Engine 821 as soon as a participant hangs up. If the conferencing is hosted by External Telebridge 849, then SS7 Network interface 823 may periodically acquire status information on all the calls it set up to find out which participants are still on the conference call and which have hung up. When it is found that a customer has hung up, a customer who is on the waiting list can be added to the call, and the billing can be stopped for the customer who has hung up.

A special class of professional services which may be scheduled and billed through the present invention is customer service calls. After buying a product, customers may be provided with a URL-type link which allows them to contact customer service for a predefined period. The predefined period may be a certain amount of calendar time, a certain number of calls, or a certain number of minutes on the phone to customer service. For problems that require high-level customer service, connections can be automatically routed to skilled personnel. In addition, a scheduling interface may be provided when all personnel are busy. With this system, there is never any need for customers to wait on hold, and access to key personnel can be limited as needed.

An analogous application includes collaborative engineering efforts, where partner companies may want to provide limited-time access to key personnel to facilitate development work at a partner company. In such an application, allowed access times can be set and the amount of time spent on the phone supporting partner companies can be automatically tracked.

### TIME AUCTION FEATURES

In addition to facilitating the scheduling, billing, and placement of calls to professional service providers at a fixed price, the present invention also facilitates the auctioning of time on the phone, both in one-to-one and group calls. Suppose celebrity Joe Famousguy wishes to raise money for his favorite charity. Using the present invention, he can post notice that he will allow 20 of his raving fans to take part in a teleconference with him. His raving fans can bid to take part in the teleconference. By allowing fans to bid, he is able to raise the maximum amount of money for his favorite charity. A further innovation dubbed an “e-raffle” entices those who are not going to bid enough to be on the call to participate in the auction anyway, so that valuable information about who likes Joe Famousguy can be gathered. The time auction method may also be used (with or without the e-raffle) for one-on-one or group teleconference time with professional service providers, such as tax professionals, software consultants, and the like.

FIG. 20 depicts a web page on which fans of Joe Famousguy might bid to be on his conference call with him. Call information fields 2101 indicate that Joe Famousguy is hosting the call on Sunday, Jan. 2, 2000 at 6PM, and that 20 people will be participating in the call. E-raffle information field 2102 indicates that 5 of the 20 people on the call will be there because they are winners of the e-raffle, indicating that the remaining 15 people on the call will be there because they are the 15 highest bidders. Minimum Participation Time field 2103 indicates that anyone who bids high enough to be on the call has to stay on the call for at least two minutes. Participants in the call are free to stay on the call longer than the minimum participation time if they wish, but if they get off the call early, they will be billed at least for the minimum participation time. The top 15 bidders are guaranteed to be on the call. If some of the top 15 bidders get off the call after their minimum participation time, some people on the waiting list (who bid less than or later than the top 15 bidders) will be called and connected to the call. Minimum Wait List Bid field 2108 indicates the minimum bid that a customer must bid to be on the waiting list.

Winning Bid field 2104 indicates that the current high bid is $60 per minute. Bid field 2108 indicates the amount per minute that the customer bids to be on the call. Maximum billing field 2105 indicates that if the customer bids high enough to be on the call and stays for the whole length of the call, the cost will be $900. Participation time limit field 2106 allows the customer to limit how long he or she will be on the call (for instance, so he or she doesn't accidentally rack up a $900 bill).

In a preferred embodiment, any bid that is not high enough to be guaranteed to be a winning bid automatically generates entries into the e-raffle, and the number of entries into the e-raffle is proportional to the bid. E-raffle odds field 2107 indicates the odds for winning the e-raffle with a one dollar bid. If the customer wants the best odds possible in the e-raffle for free (i.e. having no risk of being chosen from the waiting list and thus having to actually pay), the customer can simply bid an amount less than Waiting List Minimum Bid 2108. When customers enter bids In a preferred embodiment, Future Info checkbox 2110 is pre-checked, when the web page depicted in FIG. 21 loads, and customers can un-check it if they wish. Future Info checkbox 2110, in conjunction with the e-raffle serve to generate a marketing database much larger than the pool of people who would bid if all bidders were bidding to win. The existence of the e-raffle entices everyone who is interested in Joe Famousguy to bid. A database of all bidders who leave Future Info checkbox 2110 checked is gathered and can be used later as a valuable marketing tool.

In a preferred embodiment, if Out-Bid Notification checkbox 2112 is checked, the bidder will receive an e-mail notice if he or she is out-bid to be one of the guaranteed participants, and drops onto the waiting list. If Waiting List Notification checkbox 2113 is checked, then the bidder will receive an e-mail notice if he or she is out-bid to be on the waiting list. In a preferred embodiment, such e-mails contain hyper-links which the bidder may click to return to the website and bid higher. Bidders who bid only to be in the e-raffle may also be interested in returning to the website to keep upping their bid to be just below Minimal Waiting List Bid 2108. Each time a customer returns to the website, he or she will be shown an advertisement in advertisement box 2111.

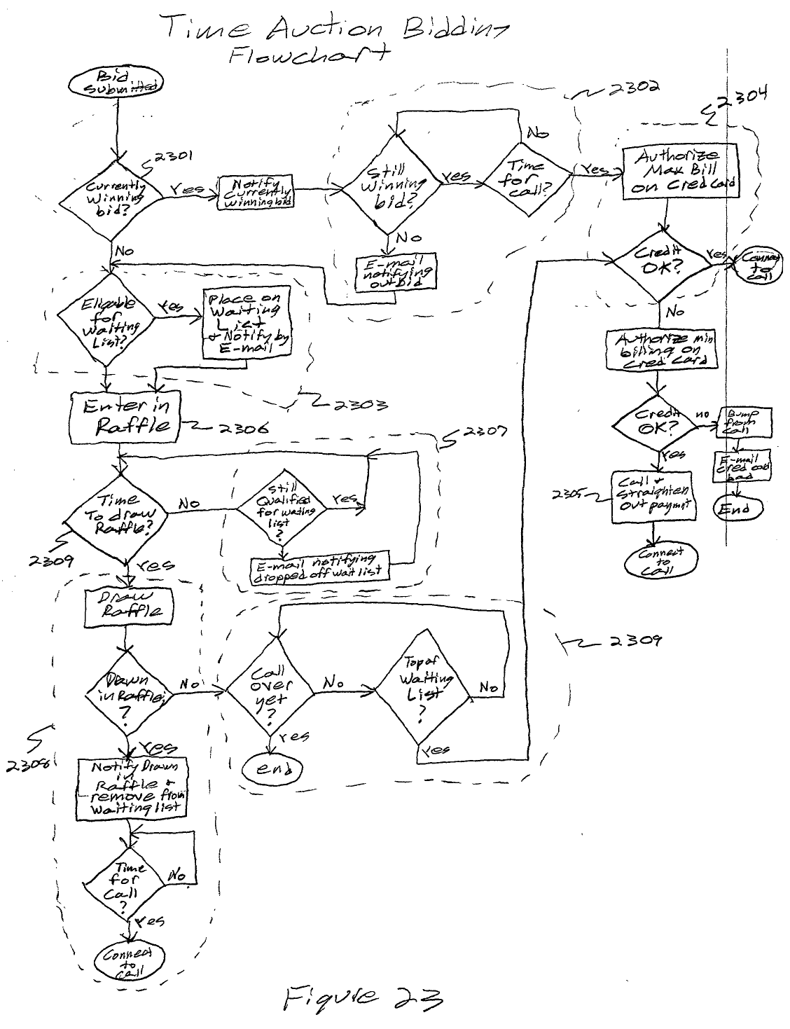

In a preferred embodiment, clicking Submit Bid button 2109 brings up a dialog box such as the one shown in FIG. 22. Bid Confirmation Dialog Box 2201 summarizes for the customer the financial commitment being made by bidding, and reminds the customer during what time frame and at what phone number the customer must be available to participate in the conference call with Joe Famousguy. If the bid submitted is too low to put the customer on the waiting list, there is no financial commitment, but the customer still has a chance to participate on the call (free) by being drawn in the e-raffle. Clicking Confirm Bid button 2202 commits the transaction. Clicking Cancel button 2203 takes the customer back to the bidding web page depicted in FIG. 21.

FIG. 23 is a flow chart depicting the method by which the time auction is run. After a bid is submitted, method 2301 determines if the bid is currently a winning bid. If it is, methods 2302 keeps watch on the bid until such time as it is no longer a winning bid (in which case a notification email is sent out to the bidder and control is passed to methods 2303) or it is time for the call to take place, in which case credit is checked by methods 2304. If methods 2304 determines that credit is OK, then the bidder is dialed and connected to the conference call. If methods 2304 determine that credit is not OK, then the bidder may be dialed by method 2305 and given a second chance to provide a valid credit card. If the bidder provides a valid credit card, then he or she is connected to the conference call.

Method 2302 determines whether the bidder is eligible to be on the waiting list, and places the bidder on the waiting list and sends an e-mail notification if the bidder is eligible, then passing control to method 2306, which enters all bidders who are not currently winning bidders into the e-raffle.

Methods 2307 determines who drops off the waiting list before the e-raffle drawing, and sends e-mail notifying those who drop off.

Method 2309 determines when it is time to draw the e-raffle. Methods 2308 determines the winners of the e-raffle, sends e-mail notification to winners, and calls and connects winners to the conference call at the appropriate time.

Methods 2309 select bidders from the waiting list as call participants drop off the call, and passes control to methods 2304 to verify credit and connect credit-worthy bidders to the conference call.

It is assumed in FIG. 23 that the bidding closes at the same time as the e-raffle drawing. If the bidding closes after the e-raffle drawing, an additional method such as 2307 must be inserted between methods 2308 and methods 2309 to manage the waiting list after the e-raffle drawing and before the call.

### OTHER APPLICATIONS

### Equivlent Alternate Embodiments

Within this disclosure, any action specified to be accomplished by clicking links or buttons or selecting options from a menu or typing a command may be considered to be accomplished equivalently by any of these methods and means. Clicking a link or button on a website may be equivalently done by clicking a mechanical or optical mouse, touching a touch-screen on a computer or PDA or WAP-enabled cell phone or web phone or web TV, pressing a button after highlighting it, typing a command, pointing with an electronic stylus pad or gyroscopic pointing device or optical pointer such as a laser pointer, pointing by looking in a given direction and having one's eye movement electronically tracked, speaking a command or menu selection into a voice command interface, or any other method of selecting or issuing a command. In any of these cases, an information signal denoting the command, menu selection, click or the like is sent from a data terminal such as a PDA (personal digital assistant), PC (personal computer), WAP-enabled phone or the like. The information signal is sent over the internet or any distributed data network.

Call progress detection methods include detecting dial, busy, re-order, and error tones spectrally, detecting digital call-progress information provided by telephone companies on digital telephone connections such as chanelized T1 connections and the like, detecting and timing voice-band energy to tell the difference between a live person and an answering machine. Many of these features are available standardly through telephony hardware manufacturers such as Natural Microsystems and telephony software manufacturers such as Mastermind Software.

It is assumed that any audio menus played on a call allows response through standard means such as touch-tones or automatic speech recognition. The term “audio command” as used in this application includes spoken commands, and menu selections entered through touch-tones.

A clickable representation of a number to be dialed might be a hyperlink shoeing the number to be dialed, or a hyperlink or button showing a pseudonym or the name of the person to be dialed, or an icon or button symbolizing the person to be dialed.

The term “member number” or “membership number” as used in this application denotes any alphanumeric or text identifier used to identify a member. A member number encrypted for use by another member refers to a member number which is not the same as the unencrypted member number, and for which there is deterministic algorithm which can uniquely translate back and forth between the encrypted member number and the unencrypted member number of a first member, given the member number of the second member.

Where member identification is necessary for retrieval of privacy-protected e-mail and access to account information, it is intended that members can easily identify themselves through any of their phone numbers in combination with their PIN code.

The term “dialing information” as it is used in this application refers to any data uniquely identifying a call to be set up in a given context. In one context, such information might be two phone numbers (to be dialed immediately and connected together). in another situation such information might be data identifying a given member and data identifying another member, where actual phone numbers are looked up in a database based on the data provided. In another situation dialing information might include directly or through a reference to stored data) a time to set up a call, a number of phone numbers to sequentially attempt to connect to, a group of phone numbers to set up as a conference call, information indicating a call scheduled to happen at a time in the future, etc.

Within this application, the term “internet-connected” shall refer to any wired or wireless, periodic or continuous connection to the internet allowing the transfer of data. “On-premises telephony equipment” as referred to in this patent application refers to all third-party (non-telephone company) hardware and software products including PC-based digital and analog telephony boards such as those manufactured by companies such as Natural Microsystems and Dialogic.

It is assumed that information specifying what time or times a call can or should take place, that specifying “time” includes specifying days of the week (repetitive or single) and calendar termination date for times specified repetitively over a number of days or weeks.

The term “professional services” as used in this application describes any situation in which time on the phone with a given person is purchased for a price higher than the price of the connection. This might include time on the phone with celebrities as a fund-raiser, as well as time on the phone with professional advisors such as tax and legal and medical advisors, as well as teleclass-style group learning teleconferences, as well as erotic phone services.

The term web page as used in this application refers includes graphical and textual web-like interfaces such as WAP-eabled phones, PDA's, and web TV.

### CLAIMS

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

Having described the invention, what is claimed is:

1. An apparatus facilitating the placing conferenced multiple outbound telephone calls, comprising:
a. an internet-connected computer for receiving dialing information over the internet;
b. an outbound call engine capable for placing a plurality of outbound telephone calls, said call engine responsive to said dialing information;
c. call conferencing means capable of connecting a plurality of outbound telephone calls together.

2. The apparatus of claim 1, wherein said internet-connected computer comprises a web server.

3. The apparatus of claim 1 wherein said call conferencing means connect said plurality of outbound calls together through third on-premises telephony equipment.

4. The apparatus of claim 1, further comprising a telephone carrier digital network command interface, and where said call conferencing means connect said plurality of outbound calls together by issuing commands through said command interface to a telephone network switch to disconnect said calls from said call engine and maintain a connection between said calls in said telephone network switch

5. The apparatus of claim 1, further comprising a database for storing customer information.

6. The apparatus of claim 1, wherein:
a. said call engine incorporates call-progress detection means capable of detecting a connected call;
b. said dialing information uniquely identifies a first customer and at least one second customer;
c. and wherein said call engine automatically dials said second customers immediately subsequent to successfully connecting to said first customer, but only if the call to said call-initiating customer connected.

7. The apparatus of claim 5, wherein said database comprises enabled-caller criteria identifying for each customer which other customers are enabled to call, and said call engine will only place calls to connect customers when said enabled-caller criteria is met.

8. The apparatus of claim 7, wherein said enabled caller information further comprises for each customer allowed contact time windows during which calls will be accepted from other customers.

9. The apparatus of claim 7, wherein customers from whom calls will be accepted can be defined as a group.

10. The apparatus of claim 9, wherein said dialing information for a customer calling as a member of a group includes both group-identifying information and individual-customer-identifying information.

11. The apparatus of claim 10, wherein said call-acceptance criteria further comprises call-blocking information specifying for each customer any individual customers from whom calls will not be accepted.

12. The apparatus of claim 7, wherein said database further comprises PIN-code information for each customer, and wherein a call-progress detector requires entry of a valid PIN code from a called customer before said customer is considered connected.

13. The apparatus of claim 7, further comprising call-acceptance criteria specifying which customers can call a given customer and which criteria are modifiable via a website by said given customer.

14. The apparatus of claim 5, further comprising means for timing telephone connection time.

15. The apparatus of claim 14, further comprising means for calculating charges based on telephone connection time, and wherein said database further comprises past charges accrued for each customer and billability status for customers, indicating whether each customer is billable for calls they set up, and whether they are billable for calls others set up to them.

16. The apparatus of claim 15, wherein said billability status further comprises whether each customer is willing to accept split-charge billing.

17. The apparatus of claim 15, wherein billability status for each customer with respect to each other customer may be individually defined.

18. The apparatus of claim 14, further comprising means for automatically providing an audio call-length reminder on a call a predetermined length of time after said call begins, and wherein said database further comprises call-length-reminder information.

19. The apparatus of claim 18, further comprising means for ending a call automatically a predetermined time after it begins.

20. The apparatus of claim 6, further comprising means of making said second customer's phone number look busy to any calls being placed through said call engine to said second number while said first number is being called and said second number has not been called yet.

21. The apparatus of claim 4, further comprising means for determining whether a line is busy through a query submitted through said telephone carrier digital network command interface.

22. The apparatus of claim 12, wherein said database further comprises call scheduling information, and conferenced outbound telephone calls may be scheduled in advance and placed at predetermined times, and call schedule data for a given customer may be accessed and modified by that customer via a website.

23. The apparatus of claim 7, further comprising means for playing to a call recipient at the beginning of a call an audio announcement identifying the other party to said call, and means for accepting an audio command disabling call acceptance from said other party prior to connecting said other party to the call.

24. The apparatus of claim 23, further comprising means for including in said audio announcement information about the last time said other party placed a conferenced outbound call between himself and said recipient.

25. The apparatus of claim 7, further comprising means for playing to a call recipient at the beginning of a call an audio greeting in said call recipient's own voice.

26. The apparatus of claim 7, wherein for each customer said database further comprises digital audio greetings recorded by said customer and data associations between particular audio greetings and particular other call recipients to whom said customer might set up calls, and further comprising means to play the appropriate associated greeting each time a call is set up by said customer to a call recipient for whom said customer has recorded and designated an associated audio greeting.

27. The apparatus of claim 11, further comprising automatic means for sending an e-mail notification to a customer if someone said customer has designated as blocked tries to set up a call to said customer.

28. The apparatus of claim 8, further comprising means to automatically notify a customer by e-mail when an enabled caller's last allowed contact time windows have expired.

29. The apparatus of claim 1, further comprising a web-based dialing directory with clickable representations of numbers to be dialed.

30. The apparatus of claim 7, further comprising means for encrypting membership numbers of other members as seen by a given member, based on the given member's own member number, and wherein customers are identified to each other through said database by uniquely encrypted member numbers.

31. The apparatus of claim 6, further comprising privacy-protected mail means for leaving a private message for an intended call recipient if an intended recipient is not reachable, said voice mail being retrievable only by the intended recipient through the use of private member-identification information.

32. The apparatus of claim 31, further comprising inbound call receiving means allowing retrieval of privacy-protected voice mail by dialing a number and entering member identification information.

33. The apparatus of claim 7, further comprising means allowing any member to automatically generate a temporary membership number for a prospective member, and means to automatically generate a permanent membership for that prospective member when that prospective member uses said temporary membership number to become a member, and automatically replace occurrences of said temporary membership number in said database with member numbers uniquely related to said permanent member number.

34. The apparatus of claim 1, further comprising means for serving a web page indicative of call placement progress.

35. The apparatus of claim 34, further comprising means to serve a web page allowing call placement options of an intended call does not go through.

36. The apparatus of claim 35, further comprising means for periodically checking a busy line, and setting up a call when said line stops being busy.

37. The apparatus of claim 36, further comprising timing means to stop the checking of the busy line after a customer-specified amount of time.

38. The apparatus of claim 7, wherein said database further comprises for each customer phone numbers at which said customer can be contacted.

39. The apparatus of claim 38, further comprising web-based sign-up and account access means, and automated outbound call placement during sign-up, wherein said outbound calls are placed to all contact numbers specified for the person signing up, and proper PIN code entry is required during said automated calls during sign-up in order to validate phone numbers to be called to reach said person.

40. The apparatus of claim 7, wherein said database further comprises information for each customer indicating at what phone numbers said customer can be dialed.

41. The apparatus of claim 40, wherein said database further comprises for each customer said customer's preferences as to what phone said customer is allowed to be called at and at what times.

42. The apparatus of claim 41, wherein said database further comprises for each customer what phone numbers said customer is reachable at by any particular other customer.

43. The apparatus of claim 7, wherein said database further comprises for each customer past call information including time of each call and member number of calling or called party, and further comprising means for serving up such past call information as web page data.

44. The apparatus of claim 43, further comprising means for disabling or enabling callers in response to web click data received from a browser viewing said past call information.

45. The apparatus of claim 5, further comprising electronic billing means for periodically billing customers for accrued charges.

46. The apparatus of claim 46, wherein said database further comprises for each customer professional services rate information, and further comprising means to charge customers for professional service time of a called party in addition to connection charges.

47. The apparatus of claim 46, further comprising means for serving up web-based schedule information for professional service providers, allowing web-based sign-up for paid telephone time with professional service providers.

48. The apparatus of claim 23, further comprising means for a called party to initiate automatic delivery of a prerecorded audio message to a caller prior to and in place of connecting said caller to said called party.

49. A method of doing business comprising auctioning professional service time on the web.

50. A method of fund-raising comprising auctioning teleconference time with celebrities on the web, automatically calling high bidders and connecting them to said teleconference, and automatically billing teleconference participants the amounts they bid to be on said teleconference.

51. A method for placing conferenced multiple outbound telephone calls, comprising:
a. An receiving dialing information over the internet;
b. placing a plurality of outbound telephone calls in response to said dialing information;
c. connecting said multiple outbound calls together as a conference call.

52. The method of claim 51, further comprising serving up a web page of account information and calling options in response to web packets containing URL and cookie information.

53. The method of claim 51 wherein said conferencing connection is done through on-premises telephony equipment.

54. The method of claim 51 wherein the connecting of said outbound calls further comprises sending digital network commands to a telephone carrier switch to offload and maintain the connection.

55. The method of claim 51, further comprising storing customer information in a database.

56. The method of claim 51, wherein:
a. Monitoring call progress to detect connection to called parties;
b. dialing at least two customers based on said dialing information;
c. dialing other parties only after a firs party has been dialed and successfully connected to.

57. The method of claim 55, wherein a call between a call-initiating party and a call-receiving party is only set up only if information in said database indicates that said call-initiating party is allowed to contact a call-receiving party.

58. The method of claim 57, further comprising checking allowed contact time window criteria in said database set up by said call-receiving party regarding said call-initiating party, and only placing said conferenced outbound calls if said call time falls within said allowed contact time criteria.

59. The method of claim 57, further comprising checking allowed group contact criteria if said dialing information indicates that said call-initiating party is initiating said call as a member of a call-enabled group, and placing said call only if said group is currently contact-enabled by said call-receiving party.

60. The method of claim 59, wherein said calling information is indicative of both individual information and group information.

61. The method of claim 60, wherein said group must be currently enabled and said individual must not be currently disabled for said call-receiving party in order for said conferenced calls to be placed.

62. The method of claim 57, further comprising automatically prompting called parties for PIN-code information and checking PIN-code information entered by call-initiating and call-receiving parties on the telephone at the beginnings of their respectively received outbound calls against PIN-code information stored for said customers in said database, and considering said outbound calls connected only if proper PIN-code information is entered.

63. The method of claim 57, further comprising serving up customer information as a web page, and accepting customer modification of customer call setup and call-receiving parameters via the internet.

64. The method of claim 55, further comprising timing connected telephone calls and storing call durations in said database.

65. The method of claim 64, further comprising calculating call charges based on connection time, connection rates, and customer billability status.

66. The method of claim 65, wherein billability status may include fully billable status, split-billing status, or non-billable status.

67. The method of claim 65, wherein the billability status of each customer may be individually defined with respect to every other customer.

68. The method of claim 64, further comprising providing an audio call-length reminder a predetermined time after the beginning of a conferenced multiple outbound call.

69. The method of claim 68, further comprising automatically ending a conferenced call a predetermined time after it begins.

70. The method of claim 68, further comprising making the call-receiving party's phone look busy to other callers using the present invention when the call-initiating party is being called to be connected to the call-receiving party.

71. The method of claim 54, further comprising determining whether a line is busy through a digital query submitted through a telephone carrier digital network command interface.

72. The method of claim 62, further comprising automatically making conferenced outbound calls at times scheduled in advance in said database.

73. The method of claim 57, further comprising automatically playing to said call-receiving party at the beginning of a call an audio announcement identifying the other party to said call, and allowing said call recipient to cancel said call without being connected to said party.

74. The method of claim 73, further comprising automatically playing to said call-receiving party at the beginning of a call audio information about the time the call-initiating party last called.

75. The method of claim 57, further comprising playing to the call-receiving party at the beginning of a call an audio greeting in the call-receiving party's own voice.

76. The method of claim 57, further comprising playing to the call-receiving party at the beginning of a call a greeting in the voice of the call-initiating party, identifying the call-initiating party.
